(19) United States
(12) Patent Application Publication
(10) Pub. No.: US 2017/0201935 A1
(43) Pub. Date: Jul. 13, 2017

(54) BASE STATION, SIGNAL TRANSMITTING METHOD OF THE SAME, COMMUNICATION SYSTEM COMPRISING THEREOF

(71) Applicant: ELECTRONICS AND TELECOMMUNICATIONS RESEARCH INSTITUTE, Daejeon (KR)

(72) Inventors: Jung Sun UM, Daejeon (KR); Hoi Yoon JUNG, Daejeon (KR); Seung Keun PARK, Daejeon (KR); Sung Jin YOO, Daejeon (KR)

(21) Appl. No.: 15/472,034

(22) Filed: Mar. 28, 2017

Related U.S. Application Data
(62) Division of application No. 15/017,361, filed on Feb. 5, 2016.

(30) Foreign Application Priority Data
Feb. 9, 2015 (KR) 10-2015-0019399
Apr. 17, 2015 (KR) 10-2015-0054521
Oct. 23, 2015 (KR) 10-2015-0148043
Jan. 18, 2016 (KR) 10-2016-0005770

(51) Int. Cl. H04W 48/16; H04W 72/04; H04L 5/00

(52) U.S. Cl. CPC H04W 48/16; H04L 5/005; H04W 72/042; H04L 27/2601

(57) ABSTRACT

An exemplary embodiment of the present information discloses a base station which transmits a discovery reference signal (DRS) in an unlicensed band, including: a transmission control unit which sets different timings to transmit the DRS for each of a plurality of channels; and a communication unit which transmits the DRS to the outside through the plurality of channels based on the set timing.

### CROSS-REFERENCE TO RELATED APPLICATIONS

This application claims priority to and the benefit of Korean Patent Application No. 10-2015-0019399 filed in the Korean Intellectual Property Office on Feb. 9, 2015, No. 10-2015-0054521 filed in the Korean Intellectual Property Office on Apr. 17, 2015, No. 10-2015-0148043 filed in the Korean Intellectual Property Office on Oct. 23, 2015, and No. 10-2016-0005770 filed in the Korean Intellectual Property Office on Jan. 18, 2016, the entire contents of which are incorporated herein by reference.

### TECHNICAL FIELD

The present invention relates to a base station, a signal transmitting method of the same, and a communication system including the same.

### BACKGROUND ART

Various wireless communication technologies have been developed along with the development of an information communication technology. The wireless communication technology is mainly classified into a wireless communication technology using a licensed band and a wireless communication technology using an unlicensed band (for example, an industrial scientific medical (ISM) band) based on a use band. A right of using the licensed band is exclusively given to one operator, so that the wireless communication technology using the licensed band may provide reliability and a communication quality which is better than those of the wireless communication technology using the unlicensed band.

A representative wireless communication technology using the licensed band includes a long term evolution (LTE) which is defined in a 3rd generation partnership project (3GPP) standard and a base station (NodeB, NB) and user equipment (UE) which support the LTE may transmit and receive signals through the licensed band. A representative wireless communication technology using the unlicensed band includes a wireless local area network (WLAN) which is defined in IEEE 802.11 standard and an access point (AP) and a station (STA) which support the WLAN may transmit and receive signals through the unlicensed band.

In the meantime, a mobile traffic is explosively increased in recent years and thus an additional licensed band needs to be secured to process the mobile traffic through the licensed band. However, the licensed band is limited and is generally secured through frequency band auction between operators so that costs are excessively charged to secure the additional licensed band. In order to solve the problems, it may be considered to provide an LTE service through the unlicensed band.

When the LTE service is provided through the unlicensed band, it is required to coexist with other unlicensed equipment such as WiFi. To this end, technologies such as listen before talk (LBT: a method which transmits a signal when the channel is free as a result of checking whether a channel is free before transmitting a signal) are required. When the LBT technology is adopted to the LTE system and the LTE system coexists with WiFi in the unlicensed band, in some cases, the signal may not be transmitted at a time desired by an LTE base station. Further, when the LTE signal transmitting method of the related art is used, WiFi signal transmission occurs during the LTE signal transmission, so that interference may be caused.

### SUMMARY OF THE INVENTION

The present invention has been made in an effort to provide a base station which may reduce conflict with other base stations when the base station transmits a signal in an unlicensed band, a signal transmitting method of the same, and a communication system including the same.

Technical objects of the present invention are not limited to the aforementioned technical objects and other technical objects which are not mentioned will be apparently appreciated by those skilled in the art from the following description.

An exemplary embodiment of the present invention provides a base station which transmits a discovery reference signal (DRS) in an unlicensed band, including: a transmission control unit which sets different timings to transmit the DRS for each of a plurality of channels; and a communication unit which transmits the DRS to the outside through the plurality of channels based on the set timing.

According to the exemplary embodiment, the transmission control unit may set the different timings in a signal transmission period which is set for the plurality of channels.

According to the exemplary embodiment, the transmission control unit may set a time offset to determine a timing at which the DRS is transmitted in the signal transmission period.

According to the exemplary embodiment, the transmission control unit may set the time offsets to be different from each other for each of the plurality of channels.

According to the exemplary embodiment, each of the plurality of channels may have the same signal transmission period.

Another exemplary embodiment of the present invention provide a signal transmitting method of a base station which transmits a discovery reference signal (DRS) in an unlicensed band, including: setting different timings to transmit the DRS for each of a plurality of channels; and transmitting the DRS to the outside through the plurality of channels based on the set timing.

According to the exemplary embodiment, in the setting of different timings to transmit the DRS for each of a plurality of channels, the different timings may be set in a signal transmission period set for the plurality of channels.

According to the exemplary embodiment, in the setting of different timings to transmit the DRS for each of a plurality of channels, a time offset to determine a timing at which the DRS is transmitted in the signal transmission period may be set.

According to the exemplary embodiment, in the setting of different timings to transmit the DRS for each of a plurality of channels, the time offsets may be set to be different from each other for each of the plurality of channels.

Yet another exemplary embodiment of the present invention provides a communication system including a base station which transmits a discovery reference signal (DRS) in an unlicensed band, including: a first base station which transmits a first DRS to the outside at different timings for each of a plurality of channels; and a second base station which transmits a second DRS to the outside at a timing which is different from that of the first DRS, through the same channel as the plurality of channels of the first base station.

According to the exemplary embodiment, the first base station may transmit the first DRS to the outside in a signal transmission period which is set for the plurality of channels and the second base station may transmit the second DRS to the outside for the plurality of channels in the signal transmission period.

According to the exemplary embodiment, the first base station may transmit the first DRS to the outside at a first timing of a first channel and may transmit the first DRS to the outside at a timing apart from the first timing of a second channel by an inter-freq. DMTC period.

According to the exemplary embodiment, the second base station may transmit the second DRS to the outside at a second timing of the first channel and transmit the second DRS to the outside at a timing apart from the second timing of the second channel by the inter-freq. DMTC period.

According to the exemplary embodiment, the second base station may set a second time offset to determine the second timing and the second time offset may be determined based on the signal transmission period and physical cell identity (PCI) of the second base station.

According to the exemplary embodiment, the inter-freq. DMTC period may be determined based on the signal transmission period and the number of the plurality of channels.

According to the exemplary embodiment, the first base station may set a first time offset to determine the first timing and the first time offset may be determined based on the signal transmission period and physical cell identity (PCI) of the first base station.

According to the exemplary embodiment, the first DRS or the second DRS may include physical downlink control channel (PDCCH) information or physical downlink shared channel (PDSCH) information.

According to the exemplary embodiment, the first DRS or the second DRS may be multiplexed with the PDCCH information or the PDSCH information in a subframe.

According to the exemplary embodiment, the first DRS or the second DRS may be multiplexed with the PDCCH information or the PDSCH information in subframe 0 or subframe 5.

According to the exemplary embodiment, the first DRS or the second DRS may be configured by 12 OFDM symbols or 13 OFDM symbols.

According to a base station, a signal transmitting method of the same, and a communication system including the same according to an exemplary embodiment of the present invention, when the base station transmits a signal in an unlicensed band, conflict with other base stations will be reduced.

### BRIEF DESCRIPTION OF THE DRAWINGS

FIG. 1 is a conceptual view illustrating a first exemplary embodiment of a wireless communication network according to an exemplary embodiment of the present invention.

FIG. 2 is a conceptual view illustrating a second exemplary embodiment of a wireless communication network according to an exemplary embodiment of the present invention.

FIG. 3 is a conceptual view illustrating a third exemplary embodiment of a wireless communication network according to an exemplary embodiment of the present invention.

FIG. 4 is a conceptual view illustrating a fourth exemplary embodiment of a wireless communication network according to an exemplary embodiment of the present invention.

FIG. 5 is a block diagram illustrating an exemplary embodiment of a communication node which configures a wireless communication network according to an exemplary embodiment of the present invention.

FIG. 6 is a view illustrating a frame structure of an LTE FDD system.

FIG. 7 is a view illustrating an example of a frame structure of an LTE TDD system.

FIG. 8 is a view illustrating a resource grid of a communication system according to an exemplary embodiment of the present invention.

FIGS. 9 to 12 are views explaining a cell-specific reference signal (CRS).

FIG. 13 is a view illustrating a location of a synchronizing signal in a frame of an FDD system.

FIG. 14 is a view illustrating a location of a synchronizing signal in a frame of a TDD system.

FIG. 15 is a view of a configuration of a discovery reference signal (DRS) of an FDD system.

FIG. 16 is a view of a configuration of a discovery reference signal of a TDD system.

FIG. 17 is a view explaining discovery reference signal measurement timing configuration period setting and a transmission period of the discovery reference signal.

FIG. 18 is a block diagram of a base station according to an exemplary embodiment of the present invention.

FIGS. 19 to 23 are views explaining an operation of a base station according to an exemplary embodiment of the present invention.

FIG. 24 is an example of a general discovery reference signal.

FIGS. 25 and 26 are examples of a discovery reference signal according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some embodiments of the present invention will be described in detail with reference to the accompanying drawings. In the figures, even though the like parts are illustrated in different drawings, it should be understood that like reference numerals refer to the same parts In describing the embodiments of the present invention, when it is determined that the detailed description of the known configuration or function related to the present invention may obscure the understanding of embodiments of the present invention, the detailed description thereof will be omitted.

In describing components of the exemplary embodiment of the present invention, terminologies such as first, second, A, B, (a), (b), and the like may be used. However, such terminologies are used only to distinguish a component from another component but nature or an order of the component is not limited by the terminologies. If it is not contrarily defined, all terminologies used herein including technological or scientific terms have the same meaning as those generally understood by a person with ordinary skill in the art. Terminologies which are defined in a generally used dictionary should be interpreted to have the same meaning as the meaning in the context of the related art but are not interpreted as an ideally or excessively formal meaning if they are not clearly defined in the present invention.

Hereinafter, a wireless communication network according to exemplary embodiments of the present invention will be described. However, the wireless communication network to which the exemplary embodiments of the present invention are applied is not limited to the following description, and the exemplary embodiments of the present invention will be applied to various wireless communication networks.

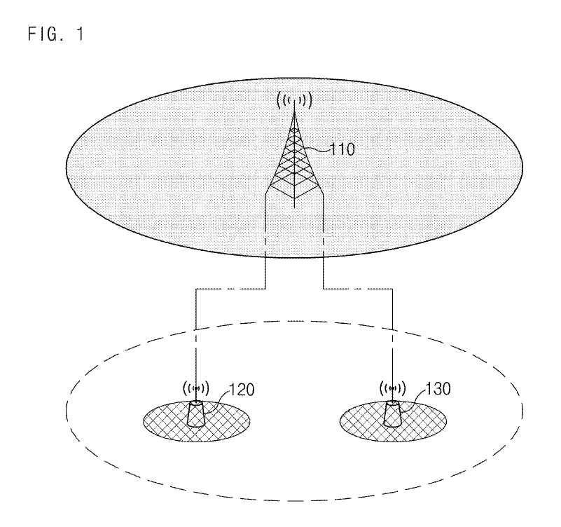

FIG. 1 is a conceptual view illustrating a first exemplary embodiment of a wireless communication network according to an exemplary embodiment of the present invention.

Referring to FIG. 1, a first base station 110 may support a cellular communication (for example, long term evolution (LTE), LTE-advanced (LTE-A), or LTE-unlicensed (LTE-U) which are defined in a 3rd generation partnership project (3GPP) standard).

The first base station 110 supports multiple input multi output (MIMO) (for example, single user (SU)-MIMO, multi user (MU)-MIMO), or massive MIMO), a coordinated multipoint (CoMP), or carrier aggregation (CA).

The first base station 110 operates in a licensed band F1 and forms a macro cell. The first base station 110 may be connected to another base station (for example, a second base station 120 or a third base station 130) through an ideal backhaul or a non-ideal backhaul.

The second base station 120 may be located in a coverage of the first base station 110. The second base station 120 operates in an unlicensed band F3 and forms a small cell.

The third base station 130 may be located in a coverage of the first base station 110. The third base station 130 operates in an unlicensed band F3 and forms a small cell. The second base station 120 and the third base station 130 may support a wireless local area network (WLAN) defined in Institute of Electrical and Electronics Engineers (IEEE) 802.11 standard. The first base station 110 and user equipment (UE, not illustrated) which is connected to the first base station 110 transmit and receive signals through carrier aggregation (CA) between the licensed band F1 and the unlicensed band F3.

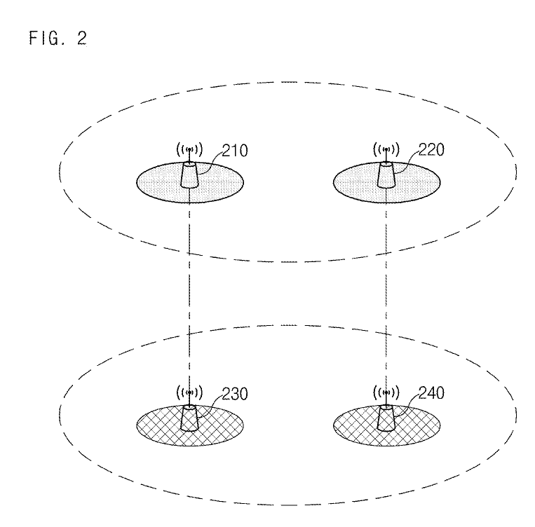

FIG. 2 is a conceptual view illustrating a second exemplary embodiment of a wireless communication network according to an exemplary embodiment of the present invention.

Referring to FIG. 2, each of a first base station 210 and a second base station 220 supports cellular communication (for example, LTE, LTE-A, or LTE-U defined in the 3GPP standard). Each of the first base station 210 and the second base station 220 supports MIMO (for example, SU-MIMO, MU-MIMO, or massive MIMO), CoMP, or CA. Each of the first base station 210 and the second base station 220 operates in a licensed band F1 and forms a small cell. Each of the first base station 210 and the second base station 220 may be located in a coverage of a base station which forms a macro cell. The first base station 210 may be connected to a third base station 230 through the ideal backhaul or the non-ideal backhaul. The second base station 220 may be connected to a fourth base station 240 through the ideal backhaul or the non-ideal backhaul.

The third base station 230 may be located in a coverage of the first base station 210. The third base station 230 operates in an unlicensed band F3 and forms a small cell. The fourth base station 240 may be located in a coverage of the second base station 220. The fourth base station 240 operates in the unlicensed band F3 and forms a small cell. Each of the third base station 230 and the fourth base station 240 supports WLAN defined in the IEEE 802.11 standard. The first base station 210 and the UE which is connected to the first base station 210, the second base station 220 and UE which is connected to the second base station 220 transmit and receive signals through carrier aggregation (CA) between the licensed band F1 and the unlicensed band F3.

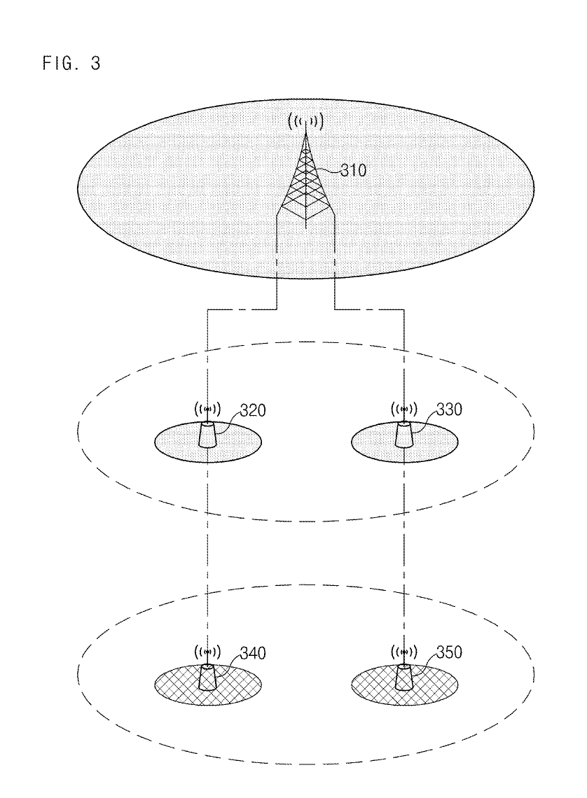

FIG. 3 is a conceptual view illustrating a third exemplary embodiment of a wireless communication network according to an exemplary embodiment of the present invention.

Referring to FIG. 3, each of a first base station 310, a second base station 320, and a third base station 330 supports cellular communication (for example, LTE, LTE-A, or LTE-U defined in the 3GPP standard). Each of the first base station 310, the second base station 320, and the third base station 330 supports MIMO (for example, SU-MIMO, MU-MIMO, or massive MIMO), CoMP, or CA.

The first base station 310 operates in a licensed band F1 and forms a macro cell. The first base station 310 may be connected to another base station (for example, the second base station 320 or the third base station 330) through an ideal backhaul or a non-ideal backhaul. The second base station 320 may be located in a coverage of the first base station 310. The second base station 320 operates in the licensed band F1 and forms a small cell. The third base station 330 may be located in a coverage of the first base station 310. The third base station 330 operates in the licensed band F1 and forms a small cell.

The second base station 320 may be connected to a fourth base station 340 through the ideal backhaul or the non-ideal backhaul. The fourth base station 340 may be located in a coverage of the second base station 320. The fourth base station 340 operates in an unlicensed band F3 and forms a small cell.

The third base station 330 may be connected to a fifth base station 350 through the ideal backhaul or the non-ideal backhaul. The fifth base station 350 may be located in a coverage of the third base station 330. The fifth base station 350 operates in the unlicensed band F3 and forms a small cell. Each of the fourth base station 340 and the fifth base station 350 supports WLAN defined in the IEEE 802.11 standard.

The first base station 310 and the UE (not illustrated) which is connected to the first base station 310, the second base station 320 and UE (not illustrated) which is connected to the second base station 320, and the third base station 330 and UE (not illustrated) which is connected to the third base station 330 transmit and receive signals through CA between the licensed band F1 and the unlicensed band F3.

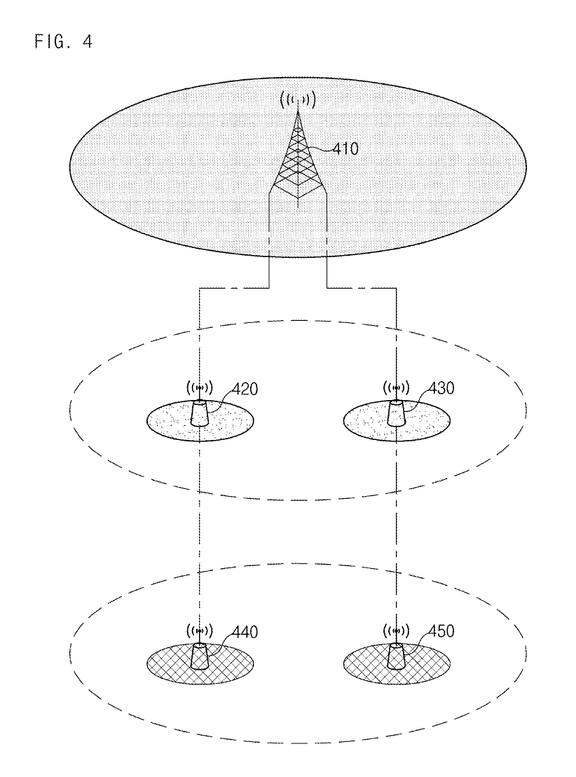

FIG. 4 is a conceptual view illustrating a fourth exemplary embodiment of a wireless communication network according to an exemplary embodiment of the present invention.

Referring to FIG. 4, each of a first base station 410, a second base station 420, and a third base station 430 supports cellular communication (for example, LTE, LTE-A, or LTE-U defined in the 3GPP standard). Each of the first base station 410, the second base station 420, and the third base station 430 supports MIMO (for example, SU-MIMO, MU-MIMO, or massive MIMO), CoMP, or CA.

The first base station 410 operates in a licensed band F1 and forms a macro cell. The first base station 410 may be connected to another base station (for example, the second base station 420 or the third base station 430) through an ideal backhaul or a non-ideal backhaul. The second base station 420 may be located in a coverage of the first base station 410. The second base station 420 operates in the licensed band F2 and forms a small cell. The third base station 430 may be located in a coverage of the first base station 410. The third base station 430 operates in the licensed band F2 and forms a small cell. That is, each of the second base station 420 and the third base station 430 may operate in a licensed band F2 which is different from the licensed band F1 in which the first base station 410 operates.

The second base station 420 may be connected to a fourth base station 440 through the ideal backhaul or the non-ideal backhaul. The fourth base station 440 may be located in a coverage of the second base station 420. The fourth base station 440 operates in an unlicensed band F3 and forms a small cell.

The third base station 430 may be connected to a fifth base station 450 through the ideal backhaul or the non-ideal backhaul. The fifth base station 450 may be located in a coverage of the third base station 430. The fifth base station 450 operates in the unlicensed band F3 and forms a small cell. Each of the fourth base station 440 and the fifth base station 450 supports WLAN defined in the IEEE 802.11 standard.

The first base station 410 and UE (not illustrated) which is connected to the first base station 410 transmit and receive signals through CA between the licensed band F1 and the unlicensed band F3. The second base station 420 and UE (not illustrated) which is connected to the second base station 420 and the third base station 430 and the UE (not illustrated) which is connected to the third base station 430, transmit and receive signals through carrier aggregation (CA) between the licensed band F2 and the unlicensed band F3.

A communication node (that is, a base station or UE) which configures the wireless communication network which is described with reference to FIGS. 1 to 4 may transmit signals based on a listen before talk (LBT) procedure in the unlicensed band. That is, the communication node may determine an occupied state of the unlicensed band by performing an energy detection operation. When it is determined that the unlicensed band is in an idle state, the communication node may transmit a signal. In this case, when the unlicensed band is in an idle state during a contention window in accordance with a random backoff operation, the communication node may transmit a signal. In contrast, when it is determined that the unlicensed band is in a busy state, the communication node may not transmit a signal.

Further, the communication node may transmit a signal based on a carrier sensing adaptive transmission (CSAT) procedure. That is, the communication node may transmit a signal based on a predetermined duty cycle. When the current duty cycle is a duty cycle which is allocated for a communication node which supports the cellular communication, the communication node may transmit a signal. In contrast, when the current duty cycle is a duty cycle which is allocated for a communication node which supports communication (for example, a WLAN) other than the cellular communication, the communication node may not transmit a signal. The duty cycle may be adaptively determined based on the number of communication nodes which support the WLAN in the unlicensed band and a usage state of the unlicensed band.

The communication node may perform discontinuous transmission in the unlicensed band. For example, when a maximum transmission duration or a maximum channel occupancy time (a maximum COT) is set in the unlicensed band, the communication node may transmit a signal within the maximum transmission duration. When the communication node does not transmit all the signals within the current maximum transmission duration, the communication node may transmit the remaining signals within a next maximum transmission duration. Further, the communication node selects a carrier which has relatively small interference in the unlicensed band and operates at the selected carrier. Further, when the communication node transmits a signal in the unlicensed band, the communication node may control a transmission power to reduce interference with another communication node.

In the meantime, the communication node may support a communication protocol based on code division multiple access (CDMA), a communication protocol based on wideband CDMA (WCDMA), a communication protocol based on time division multiple access (TDMA), a communication protocol based on frequency division multiple access (FDMA), a communication protocol based on single carrier (SC)-FDMA, a communication protocol based on orthogonal frequency division multiplexing (OFDM), and a communication protocol based on orthogonal frequency division multiple access (OFDMA).

Among the communication nodes, the base station may be referred to as a node B (NB), an evolved node B (eNB), a base transceiver station (BTS), a radio base station, a radio transceiver, an access point (AP), or an access node. Among the communication nodes, the UE may be referred to as a terminal, an access terminal, a mobile terminal, a station, a subscriber station, a portable subscriber station, a mobile station, a node, or a device.

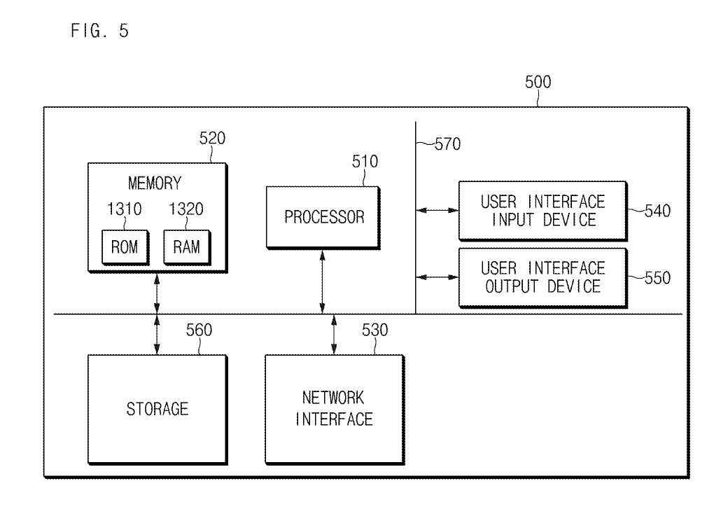

FIG. 5 is a block diagram illustrating an exemplary embodiment of a communication node which configures a wireless communication network according to an exemplary embodiment of the present invention.

Referring to FIG. 5, a communication node 500 includes at least one processor 510, a memory 520, and a transceiver device 530 which is connected to a network to perform communication. The communication node 500 further includes an input interface device 540, an output interface device 550, and a storage device 560. Configuration elements which are included in the communication node 500 may be connected to each other through a bus 570 to perform communication with each other.

The processor 510 executes a program command which is stored in at least one of the memory 520 and the storage device 560. The processor 510 may refer to a central processing unit (CPU), a graphic processing unit (GPU), or a dedicated processor by which methods according to the exemplary embodiments of the present invention are performed. Each of the memory 520 and the storage device 560 may be configured by at least one of a volatile storage medium and a nonvolatile storage medium. For example, the memory 520 may be configured by at least one of a read only memory (ROM) and a random access memory (RAM).

Next, operating methods of a communication node in a wireless communication network will be described. Even when a method which is performed (for example, transmits or receives a signal) in a first communication node among communication nodes is described, a second communication node corresponding thereto may perform a method (for example, which receives or transmits a signal) corresponding to the method performed in the first communication node. That is, when the operation of the UE is described, a corresponding base station may perform an operation corresponding to the operation of the UE. In contrast, when an operation of the base station is described, corresponding UE may perform an operation corresponding to the operation of the base station.

An unlicensed band cell is managed by being carrier aggregated (CA) with a licensed band cell. The unlicensed band cell is configured, added, modified, or released through RRC signaling (for example, an RRC connection reconfiguration message). A related RRC message is transmitted from the licensed band cell to a terminal. The RRC message may include information required for unlicensed band cell management and operation.

Differently from the licensed band cell, in the unlicensed band cell, a time to continuously transmit a signal is restricted by a maximum transmission time technical regulation condition. When it is necessary to follow a technical regulation by which the signal is transmitted after checking a channel occupancy state, the data cannot be transmitted until other wireless equipment completely transmits a signal. Therefore, transmission of the unlicensed LTE cell has non-periodic, discontinuous, and opportunistic characteristics. According to this characteristic, in the present invention, when a base station or a terminal continuously transmits a signal for a predetermined time in the unlicensed band LTE cell, it is defined as “unlicensed band burst”. Further, a continuous set of subframes by one or more combinations of a channel defined in the licensed band of the related art or a signal (for example, PCFICH, PHICH, PDCCH, PDSCH, PMCH, PUCCH, PUSCH, a synchronization signal, or a reference signal) is defined as “unlicensed band transmission”.

The unlicensed band frame is largely defined by a downlink unlicensed band burst frame, an uplink unlicensed band burst frame, and a down/up unlicensed burst frame.

The downlink unlicensed band burst frame includes at least an “unlicensed band transmission” and an “unlicensed band signal” prior to the “unlicensed band transmission”. The “unlicensed band signal” may be configured to match a transmission timing of the “unlicensed band transmission” with a licensed band subframe timing or OFDM symbol timing. The unlicensed band signal may be configured to perform AGC, or synchronization, or channel estimation which is required to receive data of the “unlicensed band transmission”.

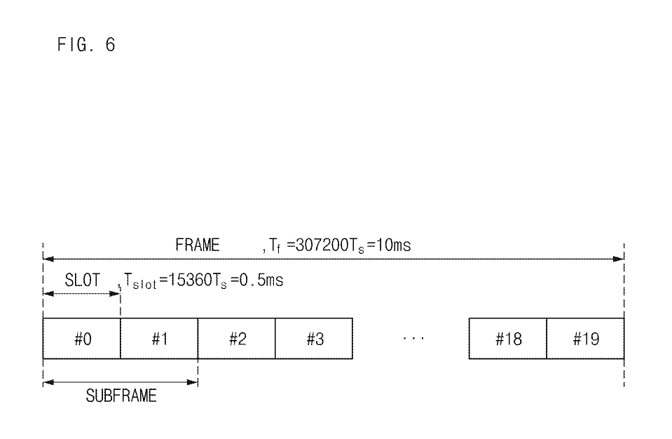

FIG. 6 is a view illustrating a frame structure of an LTE FDD system.

The 3GPP LTE system is divided into frequency division duplex (FDD) and time division duplex (TDD) and the FDD system is referred to as a type 1 frame structure and the TDD system is referred to as a type 2 frame structure.

Referring to FIG. 6, the type 1 frame structure is illustrated. In the downlink wireless frame, one frame is 10 ms and one frame may be configured by 10 subframes. In this case, a length of one subframe may be 1 ms. One subframe may be divided by two time slots and a length of one slot may be 0.5 ms.

One slot may be configured by a plurality of OFDM symbols in a time domain and configured by a plurality of resource blocks (RB) in a frequency domain. The RB may be configured by a plurality of OFDM subcarriers in the frequency domain.

The number of OFDM symbols which configure one slot may vary depending on a configuration of a cyclic prefix (CP) of the OFDM. The CP includes a normal CP and an extended CP. When the normal CP is configured, one slot may be configured by seven OFDM symbols. When the extended CP is configured, one slot may be configured by six OFDM symbols. When the normal CP is configured, one slot is configured by seven OFDM symbols and one subframe is configured by two slots, so that one subframe is configured by 14 OFDM symbols.

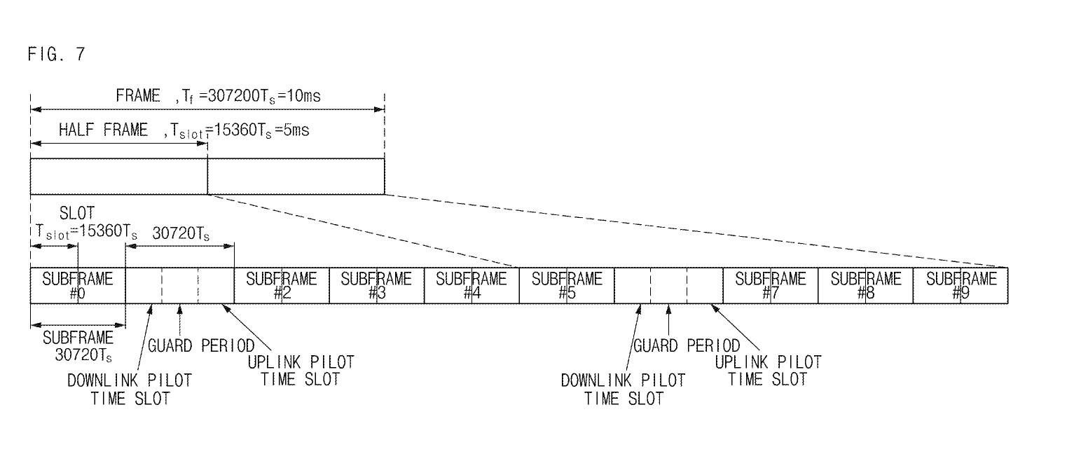

FIG. 7 is a view illustrating an example of a frame structure of an LTE TDD system.

Referring to FIG. 7, the type 2 frame structure is illustrated. One frame is configured by 10 ms, which is configured by two half frames. There are 10 subframes in one frame and a length of each subframe is 1 ms. A half frame is configured by five subframes and in the type 2 frame structure, the subframe is configured by a downlink subframe, an uplink subframe, and a special subframe.

In this case, the special subframe is configured by a downlink pilot time slot (DwPTS), a guard period, and an uplink pilot time slot (UpPTS). The downlink pilot time slot may be considered as a downlink period and used to detect a cell of the terminal or obtain time and frequency synchronization. The guard period is a period which solves an interference problem with uplink data transmission due to delay of the downlink data transmission and includes a time to switch an operation of the terminal from downlink data reception to uplink data transmission. The uplink pilot time slot may be used to estimate an uplink channel and obtain synchronization. In the configuration of the special subframe, lengths of the downlink pilot time slot, the guard period, and the uplink pilot time slot may vary in accordance with necessity. Further, in the type 2 frame structure, the number and location of the downlink subframes, the special subframes, and the uplink subframes may be changed if necessary.

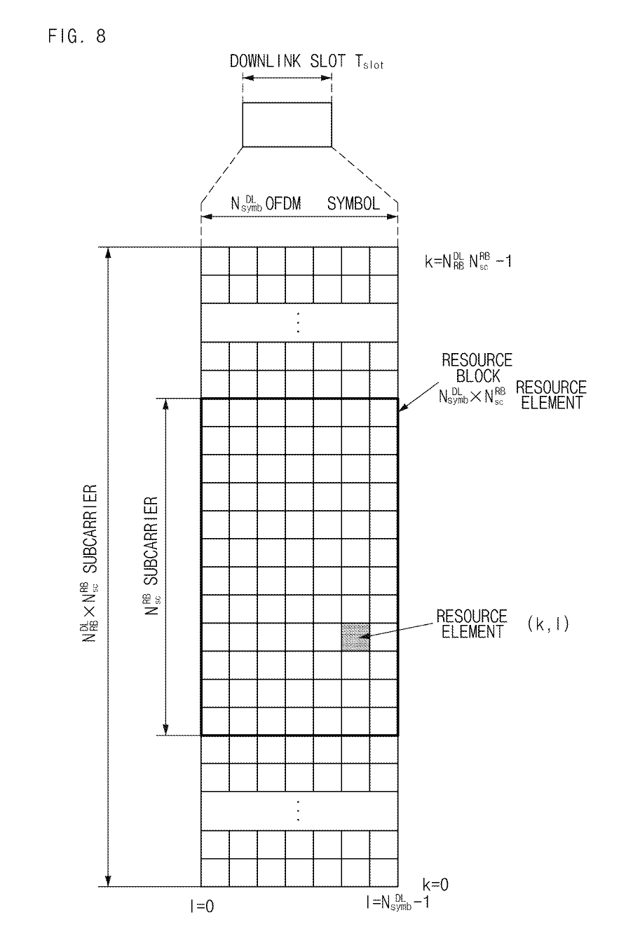

FIG. 8 is a view illustrating a resource grid of a communication system according to an exemplary embodiment of the present invention.

Referring to FIG. 8, a resource grid of a downlink slot is illustrated. When a normal CP configuration is assumed, one slot is configured by seven OFDM symbols. In the frequency domain, one RB is configured by 12 sub carriers. Therefore, one RB is configured by seven OFDM symbols in the time domain and 12 sub carriers in the frequency domain. In this case, a resource which is configured by one OFDM symbol at a time axis and one sub carrier at a frequency axis is referred to as a resource element. In the LTE downlink, resource allocation to one UE is performed in the unit of RB and a reference signal and a synchronization signal are mapped in the unit of resource element.

The reference signal is used to estimate a channel for data demodulation in the LTE and measure a channel quality. In this case, the reference signal uses a sequence and as a reference signal sequence, a constant amplitude zero auto correlation (CAZAC) sequence is used. As an example of the CAZAC sequence, a zadoff-chu (ZC) based sequence may be used. Further, as the reference signal sequence, a pseudo-random (PN) sequence may be used and examples of the PN sequence include an m-sequence, a gold sequence, and a kasami sequence. Further, as the reference signal sequence, a cyclically shifted sequence may be used.

The reference signal is classified into a cell-specific reference signal (CRS), a UE specific reference signal, and a channel status information reference signal (CSI-RS). The cell-specific reference signal is a reference signal which is transmitted to all terminals in the cell and is used to estimate a channel. The UE specific reference signal is a reference signal which is received by a specific terminal or a specific terminal group in the cell and is mainly used for the specific terminal or the specific terminal group to demodulate data. The channel status information reference signal is a reference signal to measure a quality of a channel. Hereinafter, the cell-specific reference signal will be described.

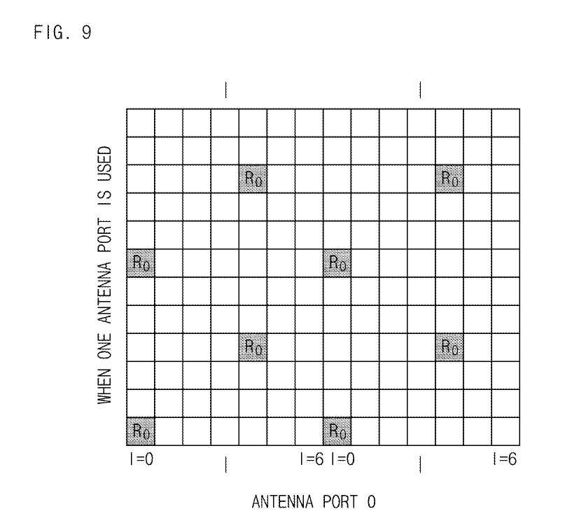

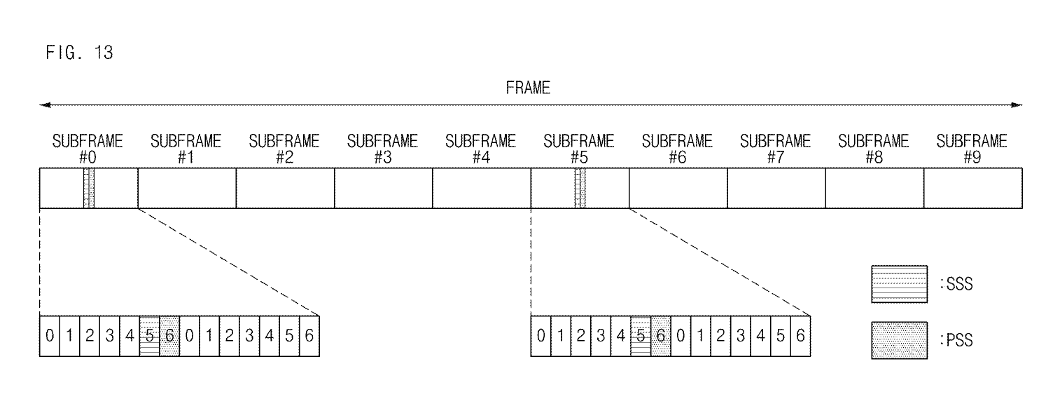

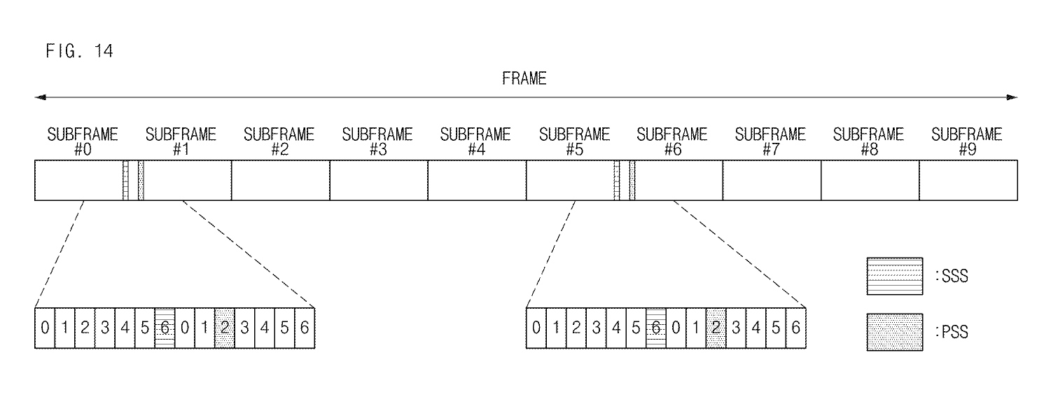

FIGS. 9 to 12 are views explaining a cell-specific reference signal (CRS). FIG. 13 is a view illustrating a location of a synchronizing signal in a frame of an FDD system. FIG. 14 is a view illustrating a location of a synchronizing signal in a frame of a TDD system.

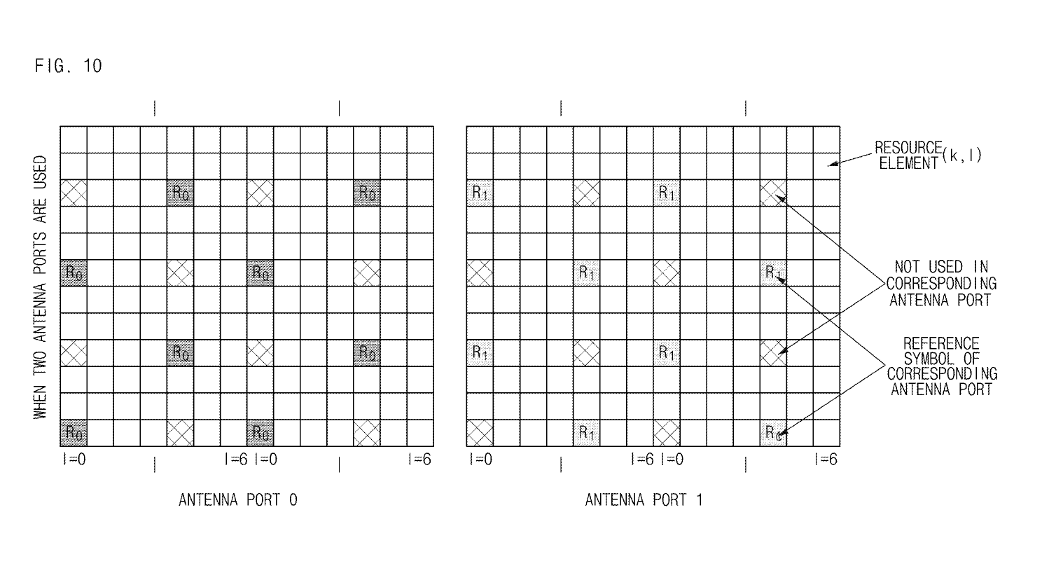

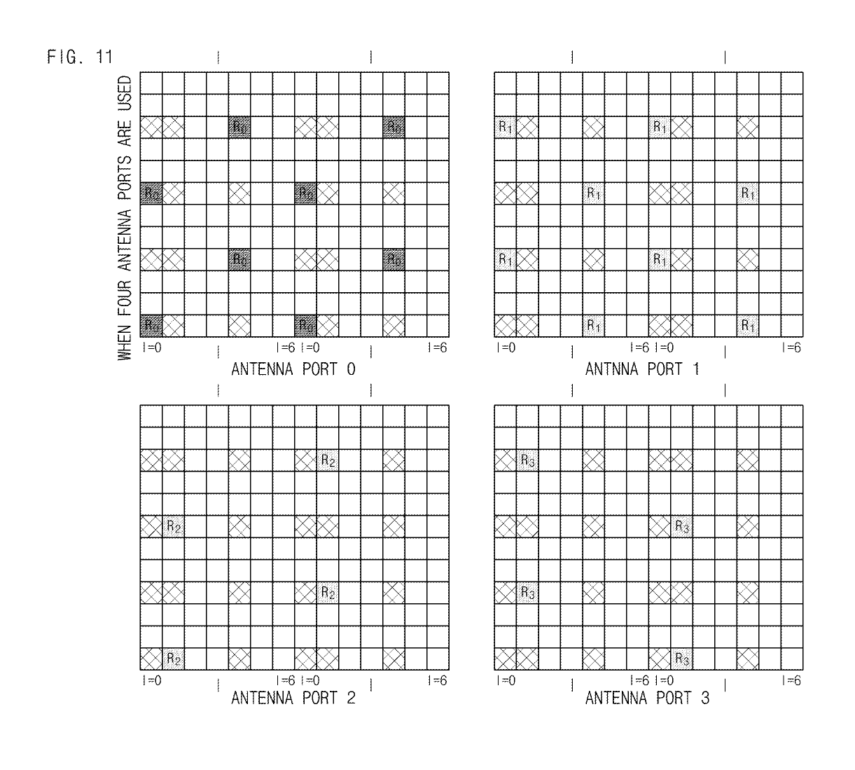

Specifically, FIG. 9 illustrates an example of a cell-specific reference signal structure (hereinafter, abbreviated as CRS) when a base station uses one antenna in a downlink of the cell, FIG. 10 illustrates an example of the CRS when the base station uses two antennas in the downlink of the cell, and FIG. 11 illustrates an example of the CRS when the base station of the cell uses four antennas in the downlink.

In the meantime, the antenna port estimates a channel for every antenna port in accordance with a logical concept but the matching with an actual physical antenna may vary in accordance with materialization. As an example, two antenna ports are used for one physical antenna so that both a reference signal of antenna port 0 and a reference signal of antenna port 1 are transmitted. As another example, the same antenna port is used for two physical antennas so that the same reference signal may be transmitted at the same time and the same frequency location.

First, referring to FIGS. 9 to 11, in the case of multiple antenna transmission when a base station uses a plurality of antennas, each antenna has one resource grid. “R0” denotes a reference signal for a first antenna, “R1” denotes a reference signal for a second antenna, “R2” denotes a reference signal for a third antenna, and “R3” denotes a reference signal for a fourth antenna. Locations of R0 to R3 in the subframe are not overlapped each other. 1 is a location of the OFDM symbol in the slot and has a value between 0 and 6 in the normal CP. Reference signals for individual antennas in one OFDM symbol are located with an interval of six subcarriers. In order to remove interference between antennas, the resource element which is used for the reference signal of one antenna may not be used for a reference signal of another antenna.

A location of the frequency domain and a location of the time domain of the CRS in the subframe may be determined regardless of the terminal. A CRS sequence which is multiplied by the CRS may also be created regardless of the terminal. Therefore, all terminals in the cell may receive the CRS. However, the location of the CRS in the subframe and the CRS sequence may be determined in accordance with a cell ID. The location of the CRS in the time domain of the subframe may be determined in accordance with a number of an antenna and the number of OFDM symbols in the resource block. The location of the CRS in the frequency domain in the subframe may be determined in accordance with a number of an antenna, a cell ID, an OFDM symbol index (l), and a slot number in a wireless frame.

The CRS sequence may be applied in the unit of an OFDM symbol in one subframe. The CRS sequence may vary in accordance with a cell ID, a slot number in one wireless frame, an OFDM symbol index in the slot, and a type of CP. The number of reference signal subcarriers for every antenna may be two on one OFDM symbol. When it is assumed that the subframe includes N resource blocks in the frequency domain, the number of reference signal subcarriers for every antenna may be 2×N RB on one OFDM symbol. Therefore, a length of the CRS sequence may be 2×N RB. The following Equation 1 represents an example of a CRS sequence.

$$[ Equation 1 ]$$

$${r}_{1 , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) , \\ m = 0 , 1 , … , 2 {N}_{RB}^{max , DL} - 1 \qquad$$

Here, nₛ is a slot number in the frame and l is an OFDM symbol number in the slot. A function c(n) is defined by the following Equation 2.

c(n)=(x₁(n+N_{C})+x₂(n+N_{C}))mod2

x₁(n+31)=(x₁(n+3)+x₁(n))mod2

x₂(n+31)=(x₂(n+3)+x₂(n+2)+x₂(n+1)+x₂(n))mod2 [Equation 2]

In this case, N_{c}=1600 and c(n) has an initial value as follows: x1(0)=1, x1(n)=0, n=1, . . . 30. An initial value cᵢₙᵢₜ of x2(n) is variously initialized in accordance with cases and initialized in accordance with a cell ID, a slot number in one wireless frame, an OFDM symbol index in the slot, a type of CP for every OFDM symbol.

An initial value cᵢₙᵢₜ of the CRS may be defined by the following Equation 3.

cᵢₙᵢₜ=2¹⁰·(7·(nₛ+1)+l+1)·(2·N_{ID}^{cell}+1)+2·N_{ID}^{cell}+N_{CP} [Equation 3]

In this case, N_{cp} is 1 in the case of the normal CP and 0 in the case of the extended CP and N_{ID}^{cell} may be a cell ID. A reference signal which is transmitted from a first OFDM symbol of a k-th subcarrier in the resource block of the antenna port p may be represented by the following Equation 4.

a_{k,l}^{(p)}=r_{l,n}_{ₛ}(m′) [Equation 4]

In this case, a subcarrier location k and an OFDM symbol location l may be defined by the following Equation 5.

$$\begin{matrix}k = 6 m + ( v + {v}_{shift} ) mod6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL}\end{matrix} \qquad [ Equation 5 ]$$

In this case, a value of v which determines a subcarrier location k may be defined by the following Equation 6.

$$v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod2 ) & if p = 2 \\ 3 + 3 ( {n}_{s} mod 2 ) & if p = 3\end{matrix} \qquad [ Equation 6 ]$$

Further, a frequency shift value v_{shift} in accordance with a cell may be determined by N_{ID}^{cell} mod 6. Here, x mod y is an operation indicating a remainder value obtained by dividing x by y.

The CRS is used to estimate channel state information (CSI) in an LTE system. If necessary through the estimation of the CSI, a channel quality indicator (CQI) a precoding matrix indicator (PMI), and a rank indicator (RI) may be reported from a terminal.

In order to reduce inter-cell interference in a multiple cell environment, for the channel status information reference signal (hereinafter, abbreviated as a CSI-RS), 32 different CSI configurations are suggested at maximum. Configurations for the CSI-RS vary in accordance with the number of ports of the antenna in the cell and the CSI-RSs are configured to have different configurations in adjacent cells as much as possible. An antenna port which transmits the CSI-RS is referred to as a CSI-RS port and a location of the resource element where the CSI-RS port(s) transmits the CSI-RS(s) is referred to as a CSI-RS pattern or a CSI-RS resource configuration. The CSI-RS supports eight antenna ports (p=15, p=15, 16, and p=15, . . . , 18, and p=15, . . . , 22) at maximum and the antenna ports p=15, . . . , 22 may correspond to the CSI-RS ports p=0, . . . , 7, respectively herein below.

The following Table 1 represents CSI-RS configurations which may be used in the FDD frame type 1 and the TDD frame type 2 and configurations in a subframe having a normal CP.

TABLE 1

| | | NUMBER OF CSI-RS CONFIGURATIONS | | | | | |
|---|---|---|---|---|---|---|---|
| | CSI-RS | 1 or 2 | | 4 | | 8 | |
| | CONFIGU- | | nₛ | | nₛ | (k’, l’) | nₛ |
| | RATION | (k’, l’) | mod 2 | (k’, l’) | mod 2 | | mod 2 |
| FRAME | 0 | (9, 5) | 0 | (9, 5) | 0 | (9, 5) | 0 |
| TYPE | 1 | (11, 2) | 1 | (11, 2) | 1 | (11, 2) | 1 |
| 1 AND 2 | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| FRAME | 20 | (11, 1) | 1 | (11, 1) | 1 | (11, 1) | 1 |
| TYPE 2 | 21 | (9, 1) | 1 | (9, 1) | 1 | (9, 1) | 1 |
| ONLY | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

When a value of (k′, l′) of Table 1 is applied to the following Equation 7, a time-frequency resource element which is used to transmit the CSI-RS by each CSI-RS port may be determined. Here, k′ is a subcarrier index in the RB and l′ is an OFDM symbol index in the slot. That is, in the slot n_{d}, α_{k,l}^{(p)} which is used as a reference symbol on the CSI-RS port p in the CSI-RS sequence may be mapped by the following Equation 7.

α_{k,l}^{(p)}=w_{l″}·r_{l,n}_{ₛ}(m′) [Equation 7]

Variables used in this case may be defined by the following Equation 8.

$$k = {k}^{′} + 12 m + \{ \begin{matrix}- 0 for p ∈ \{ 15 , 16 \} , & NORMAL CP \\ - 6 for p ∈ \{ 17 , 18 \} , & NORMAL CP \\ - 1 for p ∈ \{ 19 , 20 \} , & NORMAL CP \\ - 7 for p ∈ \{ 21 , 22 \} , & NORMAL CP \\ - 0 for p ∈ \{ 15 , 16 \} , & EXTENDED CP \\ - 3 for p ∈ \{ 17 , 18 \} , & EXTENDED CP \\ - 6 for p ∈ \{ 19 , 20 \} , & EXTENDED CP \\ - 9 for p ∈ \{ 21 , 22 \} , & EXTENDED CP\end{matrix} \\ l = {l}^{′} + \\ \{ \begin{matrix}{l}^{″} & CSI \text{-} RS CONFIGURATION 0 \text{-} 19 , NORMAL CP \\ 2 {l}^{″} & CSI \text{-} RS CONFIGURATION 20 \text{-} 31 , NORMAL CP \\ {l}^{″} & CSI \text{-} RS CONFIGURATION 0 \text{-} 27 , EXTENDED CP\end{matrix} \\ {w}_{{l}^{″}} \{ \begin{matrix}1 & p ∈ \{ 15 , 17 , 19 , 21 \} \\ {( - 1 )}^{{l}^{″}} & p ∈ \{ 16 , 18 , 20 , 22 \}\end{matrix} \\ {l}^{″} = 0 , 1 \\ m = 0 , 1 , … , {N}_{RB}^{DL} - 1 \\ {m}^{′} = m + ⌊ \frac{{N}_{RB}^{maxDL} - {N}_{RB}^{DL}}{2} ⌋ \qquad [ Equation 8 ]$$

The following Equation 9 represents an example of a CSI-RS sequence. In this case, c(n) may be used as same as in Equation 2.

$$[ Equation 9 ]$$

$${r}_{l , n ,} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{maxDL} - 1 \qquad$$

An initial value cᵢₙᵢₜ of the CSI-RS may be defined by the following Equation 10. In this case, a value of N_{ID}^{CSI} may be the same as the cell ID.

cᵢₙᵢₜ=2¹⁰·(7·(nₛ+1)+l+1)·(2·N_{ID}^{CSI}+1)+2·N_{ID}^{CSI}+N_{CP} [Equation 10]

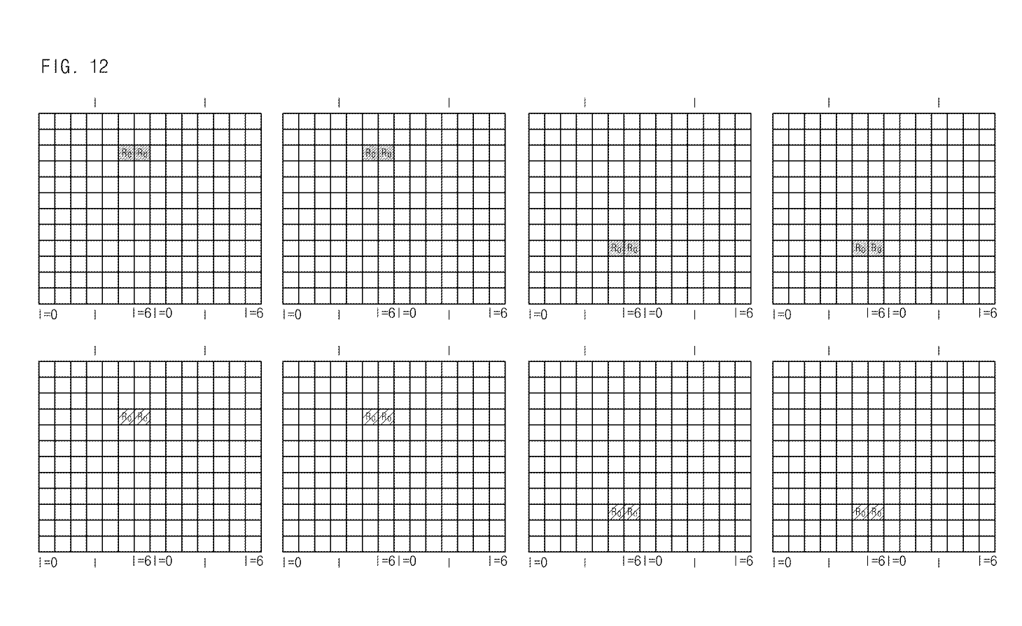

An example of CSI-RS transmission using a configuration 0 of the CSI-RS described above is illustrated in FIG. 12.

In the meantime, in the subframe configuration of the CSI-RS, as represented in the following Table 2, a CSI-RS period and a CSI-RS subframe offset may be determined in accordance with the subframe configuration value I_{CSI-RS} and in this case, the CSI-RS may be transmitted in the system frame and the slot which satisfy the following Equation 11. Here, n_{f} is a system frame number and nₛ is a slot number in the frame.

TABLE 2

| CSI-RS SUBFRAME | CSI-RS PERIOD | CSI-RS SUBFRAME |
|---|---|---|
| COFIGURATION | T_{CSI-RS} | OFFSET Δ_{CSI-RS} |
| I_{CSI-RS} | (UNIT: SUBFRAME) | (UNIT: SUBFRAME) |
| 0-4 | 5 | I_{CSI-RS} |
| 5-14 | 10 | I_{CSI-RS} − 5 |
| 15-34 | 20 | I_{CSI-RS} − 15 |
| 35-74 | 40 | I_{CSI-RS} − 35 |
| 75-154 | 80 | I_{CSI-RS} − 75 |

(10n_{f}+└nₛ/2┘−Δ_{CSI-RS})modT_{CSI-RS}=0 [Equation 11]

In the meantime, the synchronization signal refers to a signal which is transmitted from a base station such that a terminal adjusts a time and frequency synchronization with a base station or discerns the cell ID. The synchronization signal is classified into a primary synchronization signal (PSS) and a secondary synchronization signal (SSS). The primary synchronization signal is used to obtain time domain synchronization such as OFDM symbol synchronization or slot synchronization and frequency domain synchronization and the secondary synchronization signal may be used to discern the frame synchronization, a cell group ID, and a CP configuration (normal/extended) of the cell.

The primary synchronization signal of the FDD system is transmitted to a last OFDM symbol of the first slot of subframe 0 and a last OFDM symbol of the first slot of subframe 5. The secondary synchronization signal of the FDD system is transmitted to a fifth OFDM symbol of the first slot of subframe 0 and a fifth OFDM symbol of the first slot of subframe 5. A transmission location of the primary synchronization signal and the secondary synchronization signal of the FDD system using a normalized CP is illustrated in FIG. 13.

The primary synchronization signal of the TDD system is transmitted to a second OFDM symbol of the first slot of subframe 1 and a second OFDM symbol of the first slot of subframe 6. The secondary synchronization signal is transmitted to a last OFDM symbol of the second slot of subframe 0 and a last OFDM symbol of the second slot of subframe 5. A transmission location of the primary synchronization signal and the secondary synchronization signal of the TDD system using a normalized CP is illustrated in FIG. 14.

The synchronization signal is configured by sequences and different sequences are used to distinguish cell IDs. There are three types of primary synchronization signals and 168 types of secondary synchronization signals. 504 cell IDs may be discerned using combinations of three types of primary synchronization signals and 168 types of secondary synchronization signals. In this case, 168 classifications which are divided as the secondary synchronization signals are referred to as a cell group and a unique ID which may be classified as the primary synchronization signal is present in each cell group.

The cell ID may be represented by the following Equations 12 using N_{ID}⁽²⁾ of {0, 1, 2} which may be classified as the primary synchronization signal and N_{ID}⁽¹⁾ of {0, 1, 2, . . . , 167} which may be classified as the secondary synchronization signal.

N_{ID}^{Cell}=3N_{ID}⁽¹⁾+N_{ID}⁽²⁾ [Equations 12]

A sequence which is used to transmit the primary synchronization signal is a Zadoff-Chu sequence and may be defined by the following Equation 13.

$${d}_{u} ( n ) = \{ \begin{matrix}{e}^{- j \frac{Run ( n + 1 )}{63}} & n = 0 , 1 , … , 30 \\ {e}^{\frac{- jRU ( n + 1 ) ( n + 2 )}{63}} & n = 31 , 32 , … , 61\end{matrix} \qquad [ Equation 13 ]$$

Here, Zadoff-Chu root sequence index u may be defined by the following Table 3 in accordance with N_{ID}⁽²⁾.

TABLE 3

| N_{ID}⁽²⁾ | Root index u |
|---|---|
| 0 | 25 |
| 1 | 29 |
| 2 | 34 |

A transmission location of the primary synchronization signal defined above at the frequency axis is defined by the following Equation 14. In this case, k is an index at the frequency axis and l is an index at the time axis and the location of the primary synchronization signal at the time axis is as illustrated in FIGS. 13 and 14.

$${α}_{k , i} = d ( n ) , n = 0 , … , 61 \\ k = n - 31 + \frac{{N}_{RB}^{DL} {N}_{SC}^{RB}}{2} \qquad [ Equation 14 ]$$

In this case, N_{RB}^{DL} is a total number of RBs of the downlink system and N_{RB}^{DL} is the number of subcarriers for one RB. In the meantime, the primary synchronization signal is transmitted to the position of Equation 14 in order to transmit the primary synchronization signal and a signal may not be transmitted to the location defined by the following Equation 15 in order to guard the subcarrier.

$$\begin{matrix}k = n - 31 + \frac{{N}_{RB}^{DL} {N}_{SC}^{RB}}{2} \\ n = - 5 , - 4 , … , - 1.62 , 63 , … , 66\end{matrix} \qquad [ Equation 15 ]$$

The secondary synchronization signal is configured to have interleaved concatenation of two m-sequences having a length of 31. The sequence which configures the secondary synchronization signal is configured in accordance with a location of the subframe, the subframe 0, and the subframe 5 as represented in the following Equation 16.

$$\begin{matrix}\begin{matrix}d ( 2 n ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} \\ d ( 2 n + 1 ) = \{ \begin{matrix}{s}_{1}^{( {m}_{1} )} ( n ) {c}_{1} ( n ) {z}_{1}^{( {m}_{0} )} ( n ) & in subframe 0 \\ {s}_{0}^{( {m}_{0} )} ( n ) {c}_{1} ( n ) {z}_{1}^{( {m}_{1} )} ( n ) & in subframe 5\end{matrix}\end{matrix} & \end{matrix} \qquad [ Equation 16 ]$$

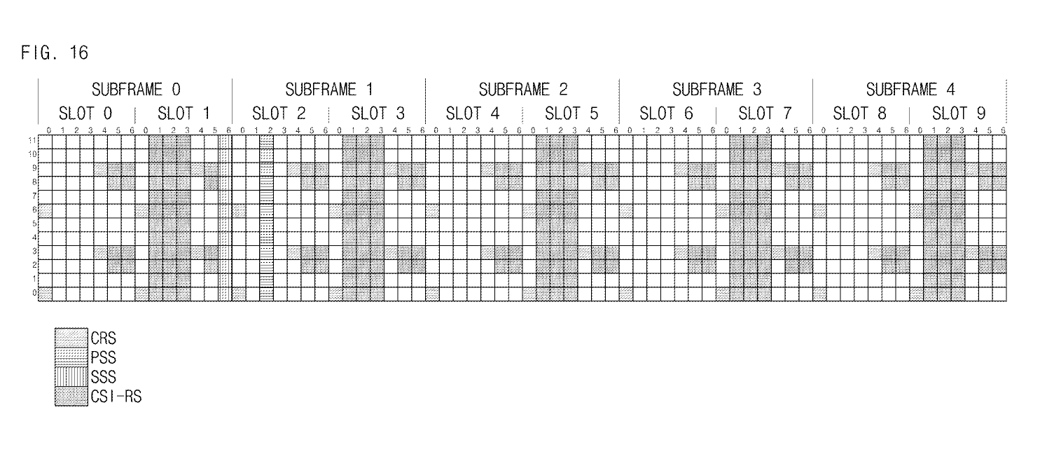

Here, n has a value from 0 to 31. Values of m₀ and m₁ in accordance with N_{ID}⁽¹⁾ in FIG. 16 are defined by the following Table 4.

TABLE 4

| N_{ID}⁽¹⁾ | m₀ | m₁ |
|---|---|---|
| 0 | 0 | 1 |
| 1 | 1 | 2 |
| 2 | 2 | 3 |
| 3 | 3 | 4 |
| 4 | 4 | 5 |
| 5 | 5 | 6 |
| 6 | 6 | 7 |
| 7 | 7 | 8 |
| 8 | 8 | 9 |
| 9 | 9 | 10 |
| 10 | 10 | 11 |
| 11 | 11 | 12 |
| 12 | 12 | 13 |
| 13 | 13 | 14 |
| 14 | 14 | 15 |
| 15 | 15 | 16 |
| 16 | 16 | 17 |
| 17 | 17 | 18 |
| 18 | 18 | 19 |
| 19 | 19 | 20 |
| 20 | 20 | 21 |
| 21 | 21 | 22 |
| 22 | 22 | 23 |
| 23 | 23 | 24 |
| 24 | 24 | 25 |
| 25 | 25 | 26 |
| 26 | 26 | 27 |
| 27 | 27 | 28 |
| 28 | 28 | 29 |
| 29 | 29 | 30 |
| 30 | 0 | 2 |
| 31 | 1 | 3 |
| 32 | 2 | 4 |
| 33 | 3 | 5 |
| 34 | 4 | 6 |
| 35 | 5 | 7 |
| 36 | 6 | 8 |
| 37 | 7 | 9 |
| 38 | 8 | 10 |
| 39 | 9 | 11 |
| 40 | 10 | 12 |
| 41 | 11 | 13 |
| 42 | 12 | 14 |
| 43 | 13 | 15 |
| 44 | 14 | 16 |
| 45 | 15 | 17 |
| 46 | 16 | 18 |
| 47 | 17 | 19 |
| 48 | 18 | 20 |
| 49 | 19 | 21 |
| 50 | 20 | 22 |
| 51 | 21 | 23 |
| 52 | 22 | 24 |
| 53 | 23 | 25 |
| 54 | 24 | 26 |
| 55 | 25 | 27 |
| 56 | 26 | 26 |
| 57 | 27 | 29 |
| 58 | 28 | 30 |
| 59 | 0 | 3 |
| 60 | 1 | 4 |
| 61 | 2 | 5 |
| 62 | 3 | 6 |
| 63 | 4 | 7 |
| 64 | 5 | 8 |
| 65 | 6 | 9 |
| 66 | 7 | 10 |
| 67 | 8 | 11 |
| 68 | 9 | 12 |
| 69 | 10 | 13 |
| 70 | 11 | 14 |
| 71 | 12 | 15 |
| 72 | 13 | 16 |
| 73 | 14 | 17 |
| 74 | 15 | 18 |
| 75 | 16 | 19 |
| 76 | 17 | 20 |
| 77 | 18 | 21 |
| 78 | 19 | 22 |
| 79 | 20 | 23 |
| 80 | 21 | 24 |
| 81 | 22 | 25 |
| 82 | 23 | 26 |
| 83 | 24 | 27 |
| 84 | 25 | 28 |
| 85 | 26 | 29 |
| 86 | 27 | 30 |
| 87 | 0 | 4 |
| 88 | 1 | 5 |
| 89 | 2 | 6 |
| 90 | 3 | 7 |
| 91 | 4 | 8 |
| 92 | 5 | 9 |
| 93 | 6 | 10 |
| 94 | 7 | 11 |
| 95 | 8 | 12 |
| 96 | 9 | 13 |
| 97 | 10 | 14 |
| 98 | 11 | 15 |
| 99 | 12 | 16 |
| 100 | 13 | 17 |
| 101 | 14 | 18 |
| 102 | 15 | 19 |
| 103 | 16 | 20 |
| 104 | 17 | 21 |
| 105 | 18 | 22 |
| 106 | 19 | 23 |
| 107 | 20 | 24 |
| 108 | 21 | 25 |
| 109 | 22 | 26 |
| 110 | 23 | 27 |
| 111 | 24 | 28 |
| 112 | 25 | 29 |
| 113 | 26 | 30 |
| 114 | 0 | 5 |
| 115 | 1 | 6 |
| 116 | 2 | 7 |
| 117 | 3 | 8 |
| 116 | 4 | 9 |
| 119 | 5 | 10 |
| 120 | 6 | 11 |
| 121 | 7 | 12 |
| 122 | 8 | 13 |
| 123 | 9 | 14 |
| 124 | 10 | 15 |
| 125 | 11 | 16 |
| 126 | 12 | 17 |
| 127 | 13 | 18 |
| 128 | 14 | 19 |
| 129 | 15 | 20 |
| 130 | 16 | 21 |
| 131 | 17 | 22 |
| 132 | 18 | 23 |
| 133 | 19 | 24 |
| 134 | 20 | 25 |
| 135 | 21 | 26 |
| 136 | 22 | 27 |
| 137 | 23 | 28 |
| 138 | 24 | 29 |
| 139 | 25 | 30 |
| 140 | 0 | 6 |
| 141 | 1 | 7 |
| 142 | 2 | 8 |
| 143 | 3 | 9 |
| 144 | 4 | 10 |
| 145 | 5 | 11 |
| 146 | 6 | 12 |
| 147 | 7 | 13 |
| 148 | 8 | 14 |
| 149 | 9 | 15 |
| 150 | 10 | 16 |
| 151 | 11 | 17 |
| 152 | 12 | 18 |
| 153 | 13 | 19 |
| 154 | 14 | 20 |
| 155 | 15 | 21 |
| 156 | 16 | 22 |
| 157 | 17 | 23 |
| 158 | 18 | 24 |
| 159 | 19 | 25 |
| 160 | 20 | 26 |
| 161 | 21 | 27 |
| 162 | 22 | 28 |
| 163 | 23 | 29 |
| 164 | 24 | 30 |
| 165 | 0 | 7 |
| 168 | 1 | 8 |
| 167 | 2 | 9 |
| — | — | — |
| — | — | — |

In this case, a value suggested in Table 4 is a value calculated by the following Equation 17.

$$\begin{matrix}{m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID}^{( 1 )} + q ( q + 1 ) / 2 , q = ⌊ \frac{{N}_{ID}^{( 1 )} + {q}^{′} ( {q}^{′} + 1 ) / 2}{30} ⌋ \\ {q}^{′} = ⌊ {N}_{ID}^{( 1 )} / 30 ⌋ ,\end{matrix} \qquad [ Equation 17 ]$$

Further, in Equation 16, a function s( ) is defined by the following Equation 18.

s₀^{(m}^{₀}⁾(n)=\tilde{s}((n+m₀)mod31)

s₁^{(m}^{₁}⁾(n)=\tilde{s}((n+m₁)mod31) [Equation 18]

In this case, \tilde{s}(i)=1−2x(i), 0≦i≦30 is satisfied and x( ) is defined by the following Equation 19.

x(ī+5)=(x(ī+2)+x(i̅))mod2, 0≦i≦25 [Equation 19]

An initializing condition of Equation 19 is x(0)=0, x(1)=0, x(2)=0, x(3)=0, x(4)=1.

Further, in Equation 16, c( ) is defined by the following Equation 20.

c₀(n)=\tilde{c}((n+N_{ID}⁽²⁾)mod31)

c₁(n)=\tilde{c}((n+N_{ID}⁽²⁾+3)mod31) [Equation 20]

Here, N_{ID}⁽²⁾ is an identification ID in the cell group which is used to create the primary synchronization signal and has a value of one of {0, 1, 2}. In this case, \tilde{c}(i)=1−2x(i)0≦i≦30 is satisfied and x(i) is defined by the following Equation 21.

x(ī+5)=(x(ī+3)+x(ī))mod2, 0≦ī≦25 [Equation 21]

In this case, an initial value of x(i) is as follows. x(0)=0, x(1)=0, x(2)=0, x(3)=0, x(4)=1.

In the meantime, in Equation 16, z( ) is defined by the following Equation 22.

z₁^{(m}^{₀}⁾(n)=\tilde{z}((n+(m₀ mod8))mod31)

z₁^{(m}^{₁}⁾(n)=\tilde{z}((n+(m₁ mod8))mod31) [Equation 22]

In this case, values of m₀ and m₁ are as defined in Table 4 and defined by \tilde{z}(i)=1−2x(i), 0≦i≦0. In this case, x( ) may be defined by the following Equation 23.

x(ī+5)=(x(ī+4)+x(ī+2)+x(ī+1)+x(i̅))mod2, 0≦ī≦25 [Equation 23]

An initial value of Equation 23 is as follows. x(0)=0, x(1)=0, x(2)=0, x(3)=0, x(4)=1. A transmission location of the secondary synchronization signal defined above is defined by the following Equation 24.

$$\begin{matrix}{α}_{k , i} = d ( n ) , n = 0 , … , 61 \\ k = n - 31 + \frac{{N}_{RB}^{DL} {N}_{SC}^{RB}}{2} \\ l = \{ \begin{matrix}{N}_{symb}^{DL} - 2 , IN FDD SYSTEM \\ {N}_{symb}^{DL} - 1 , IN TDD SYSTEM\end{matrix}\end{matrix} \qquad [ Equation 24 ]$$

In this case, N_{RB}^{DL} is a total number of RBs of the downlink system and N_{RB}^{DL} is the number of subcarriers for one RB. Further, a transmission location l at the time axis is as illustrated in FIGS. 13 and 14. In the meantime, in order to transmit the secondary synchronization signal, the secondary synchronization signal is transmitted to the location calculated by Equation 24 and the signal may not be transmitted to the location defined by the following Equation 25 in order to guard the subcarrier.

$$\begin{matrix}k = n - 31 + \frac{{N}_{RB}^{DL} {N}_{SC}^{RB}}{2} \\ l = \{ \begin{matrix}{N}_{symb}^{DL} - 2 , in FDD SYSTEM \\ {N}_{symb}^{DL} - 1 , in TDD SYSTEM\end{matrix} \\ n = - 5 , - 4 , … , - 1.62 , 63 , … , 66\end{matrix} \qquad [ Equation 25 ]$$

In the meantime, in the unlicensed band cell, the base station may transmit a discovery signal or a discovery reference signal (hereinafter, abbreviated as a DRS) for radio resource measurement and detection of a time and frequency synchronization.

The DRS may be configured by one to five subframes in the case of the FDD system and may be configured by two to five subframes in the case of the TDD system. A signal component in each DRS may be configured by a cell-specific reference signal (CRS), a primary synchronization signal (PSS), a secondary synchronization signal (SSS), and a non-zero-power channel-state information (CSI) reference signal (CSI-RS) corresponding to antenna port 0.

When the DRS is configured by two or more subframes in the FDD system, the PSS and the SSS may be transmitted to the first subframe. In the case of the TDD system, the SSS is transmitted to the first subframe and the PSS is transmitted to the second subframe.

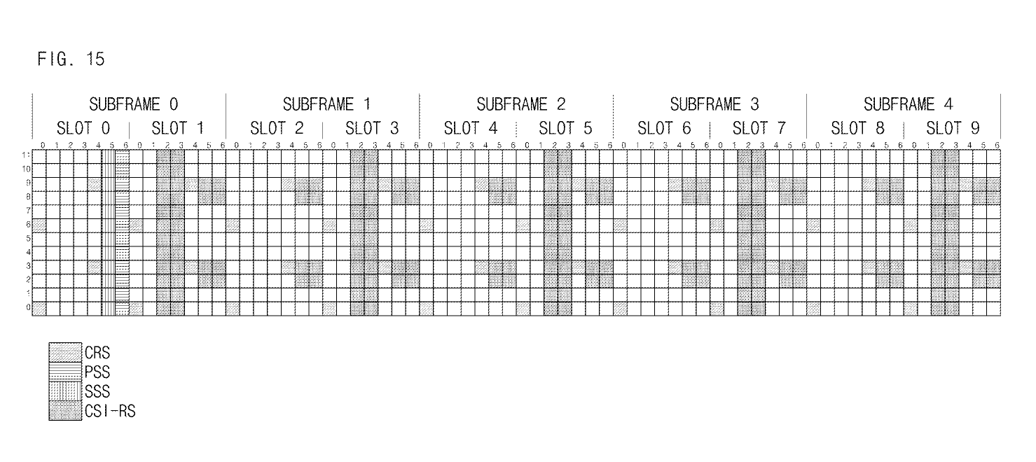

FIG. 15 is a view of a configuration of a discovery reference signal (DRS) of an FDD system.

In FIG. 15, an example of a configuration and a transmission of the DRS in the FDD system is illustrated. A basic configuration of the DRS is configured by the CRS, the PSS, the SSS, and the CSI-RS of antenna port 0. In this case, the CSI-RS may be omitted if not necessary.

In this case, when the DRS configuration at the time axis is checked from the DRS configuration for one resource block (RB) pair in subframe 0 of FIG. 15, as seen from the unit of an orthogonal frequency division multiplexing (OFDM) symbol, the CRS is transmitted to OFDM symbol 0 but no signal is transmitted to OFDM symbols 1 to 3, as seen from time slot 0. The CRS is transmitted to OFDM symbol 4, the SSS is transmitted to OFDM symbol 5, and the PSS is transmitted to OFDM symbol 6. With respect to OFDM symbols 5 and 6, the CSI-RS may be configured instead of the PSS and the SSS. In time slot 1, the CRS is transmitted to OFDM symbol 0, no signal is transmitted to OFDM symbol 1, the CSI-RS is transmitted to OFDM symbols 2 and 3, CRS is transmitted to OFDM symbol 4, and the CSI-RS is transmitted to OFDM symbols 5 and 6.

Configurations of the CRS and the CSI-RS in subframes 1 to 4 are the same as those of subframe 0, and the CRS and the CSI-RS may be transmitted while omitting the PSS and the SSS. In this case, in the OFDM symbol location to which the PSS and the SSS are transmitted in subframe 0, the CSI-RS may be transmitted to subframes 1 to 4. In this case, the number of subcarriers occupied by the CSI-RS may be different from that of the PSS and the SSS.

FIG. 16 is a view of a configuration of a discovery reference signal of a TDD system.

In FIG. 16, an example of a configuration and a transmission of the DRS and in the TDD system is illustrated. In the DRS configuration at the time axis in the DRS configuration for one RB pair in subframes 0 and 1 of FIG. 16, as seen from the unit of OFDM symbol, the CRS is transmitted to OFDM symbol 0 but no signal is transmitted to OFDM symbols 1 to 3, as seen from time slot 0. The CRS is transmitted to OFDM symbol 4 and the CSI-RS is transmitted to the OFDM symbols 5 and 6.

In time slot 1, the CRS is transmitted to OFDM symbol 0, the CSI-RS is transmitted to OFDM symbols 1 to 3, the CRS is transmitted to OFDM symbol 4, and the CSI-RS is transmitted to OFDM symbols 5 and 6. In this case, depending on the location of the RB, in the RB in a location where the SSS is transmitted, the SSS may be transmitted to OFDM symbol 6, instead of the CSI-RS.

In subframe 1, the CRS may be transmitted to OFDM symbol 0 of slot 2 and no signal may be transmitted to OFDM symbol 1. The PSS is transmitted to OFDM symbol 2 or the CSI-RS is transmitted to the OFDM symbols 2 and 3. In this case, when the CSI-RS is configured in the corresponding location, the CSI-RS is transmitted and when the location of the RB is a location where the PSS is transmitted, the PSS may be transmitted. The CRS is transmitted to OFDM symbol 4 and the CSI-RS is transmitted to the OFDM symbols 5 and 6.

In time slot 3, the CRS is transmitted to OFDM symbols 0 and 4 and the CSI-RS is transmitted to OFDM symbols 2, 3, 5, and 6. No signal may be transmitted to OFDM symbol 1.

Configurations of the CRS and the CSI-RS in subframes 3 to 5 are the same as those of subframes 0 and 1, and the CRS and the CSI-RS may be transmitted while omitting the PSS and the SSS or the PSS and the SSS are also transmitted.

When the PSS and the SSS are also transmitted, the SSS is transmitted to subframes 2 and 4 and the PSS is transmitted to subframe 3. When the PSS and the SSS are omitted, in the OFDM symbol location in subframes 0 and 1 where the PSS and the SSS are transmitted, the CSI-RS is transmitted to subframes 2 to 4. In this case, the number of subcarriers occupied by the CSI-RS may be different from that of the PSS and the SSS.

Illustrated in FIGS. 15 and 16 are DRS transmission examples using five subframes as one example and when the DRS subframe configuration is smaller than the five subframes, the DRS may be transmitted in the ascending order of the subframe number. For example, the DRS configuration and transmission are performed on three subframes, among the DRS configurations suggested in FIGS. 15 and 16, subframes 0 to 2 are configured and transmitted.

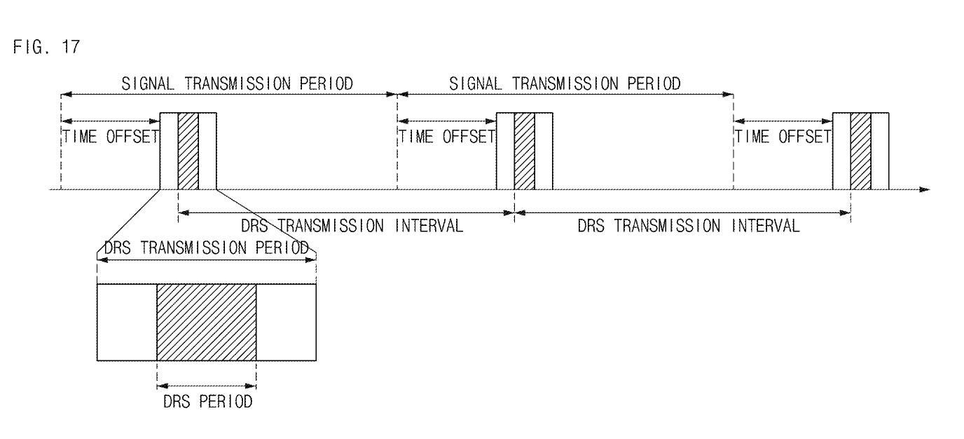

FIG. 17 is a view explaining discovery reference signal measurement timing configuration period setting and a transmission period of the discovery reference signal.

Referring to 17, a discovery reference signal measurement timing configuration period (DMTC period) is information which is notified to the terminal by the base station so that the terminal receives a DRS and the terminal detects the DRS under the assumption that the DRS is transmitted within the DMTC period. An interval of the DMTC period may be set to be 40 ms, 80 ms, or 160 ms and in some cases, may be set to be equal to or shorter than 40 ms. Regarding time offset setting of the DMTC period, when a variable T is defined by the following Equation 26, the DMTC period starts at a system frame number and a subframe number which satisfy Equations 27 and 28. In this case, in Equation 27, FLOOR(X) is a minimum integer value which is larger than X. A length of the DRS transmission period may be 6 ms. Further, a timing which is a criterion for time offset setting of the DMTC period, such as a system frame number and the subframe number may be identified with a timing of the PCell when carrier aggregation is applied.

T=Interval of DMTC period/10 [Equation 26]

System frame number mod T=FLOOR(Time offset/10) [Equation 27]

Subframe number=Timeoffset mod 10 [Equation 28]

The base station transmits the DRS in the DMTC period of the terminal and the period when the DRS is transmitted is referred to as a DRS transmission period. In this case, the DRS transmission period may be configured from one subframe to five subframes. Further, an interval when the DRS is transmitted is referred to as a DRS transmission interval, which may be identified with an interval of the DMTC period. In the meantime, a DRS transmission timing may be determined to be identified with a timing of a cell at which the DRS is transmitted.

In the licensed band, the DRS is transmitted in the signal transmitting period in a state where a cell is deactivated with respect to a RRC configured cell. Even though the cell is deactivated, the base station periodically transmits the DRS and the terminal receives the DRS to maintain the time and the frequency synchronization and measure and estimate the channel status. Therefore, when the cell is activated, the communication is immediately performed without consuming a time and a time for frequency synchronization and it is also used to determine activation of the cell. In the licensed band, a frequency for every operator is determined in advance, so that a base station of a specific operator uses only a specific frequency. Therefore, the above-mentioned processes through the DRS transmission are performed for RRC configured frequency and cell.

In the meantime, in the unlicensed band, the base station may transmit the DRS to a frequency and a cell which are not RRC configured in order to measure the channel state and obtain a time and frequency synchronization.

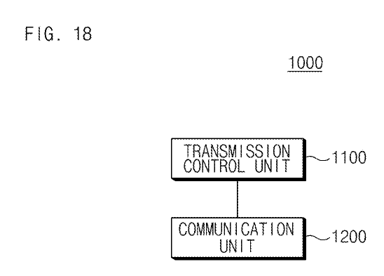

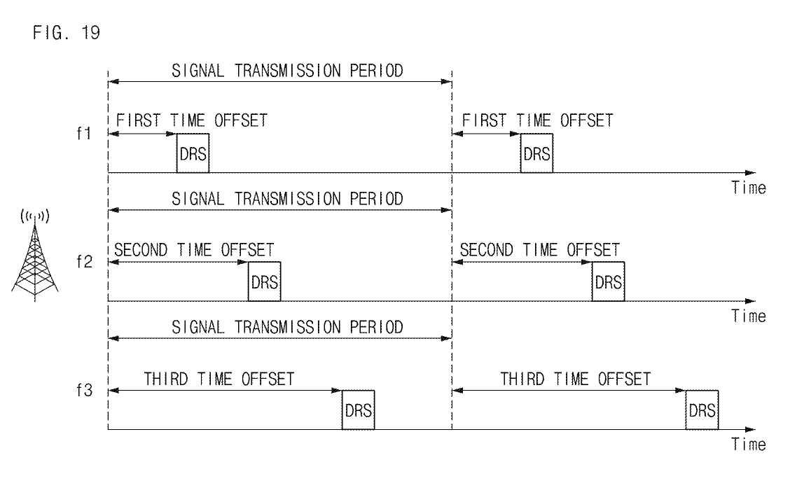

FIG. 18 is a block diagram of a base station according to an exemplary embodiment of the present invention. FIGS. 19 to 23 are views explaining an operation of a base station according to an exemplary embodiment of the present invention.

First, referring to FIGS. 18 and 19, a base station 1000 according to an exemplary embodiment of the present invention includes a transmission control unit 1100 and a communication unit 1200.

The base station 1000 transmits a DRS to a terminal through a plurality of channels in an unlicensed band. The base station 1000 sets different transmission times (that is, timings) for a plurality of available channels in the unlicensed band to transmit the DRS.

To this end, the transmission control unit 1100 sets different timings for the plurality of channels to transmit the DRS. The DRS is transmitted in a DMTC period and the DMTC period may be the same for every channel. For example, the transmission control unit 1100 may set a different time offset to determine a timing at which the DRS is transmitted, for every channel.

The communication unit 1200 transmits the DRS to the outside through the plurality of channels based on the timing set by the transmission control unit 1100.

Referring to FIG. 19, the DRS is transmitted based on a first set time offset in a first channel (that is, a frequency f1), the DRS is transmitted based on a second time offset in a second channel (that is, a frequency f2), and the DRS is transmitted based on a third time offset in a third channel (that is, a frequency f3). The first time offset, the second time offset, and the third time offset may have different values.

Therefore, the DRS is transmitted at all the plurality of channels f1, f2, and f3, so that the terminal which receives the DRS may measure channel statuses for all channels with the base station. The terminal selects a channel having a good channel environment to perform communication with the base station, thereby improving a system performance. Further, it is also possible to quickly connect a communication link in accordance with an on-state of the base station, which is an original purpose of the transmission of the DRS.

In the meantime, in the above example, the DRS transmission method in an environment in which only one base station for a plurality of channels in the unlicensed band is provided has been described.

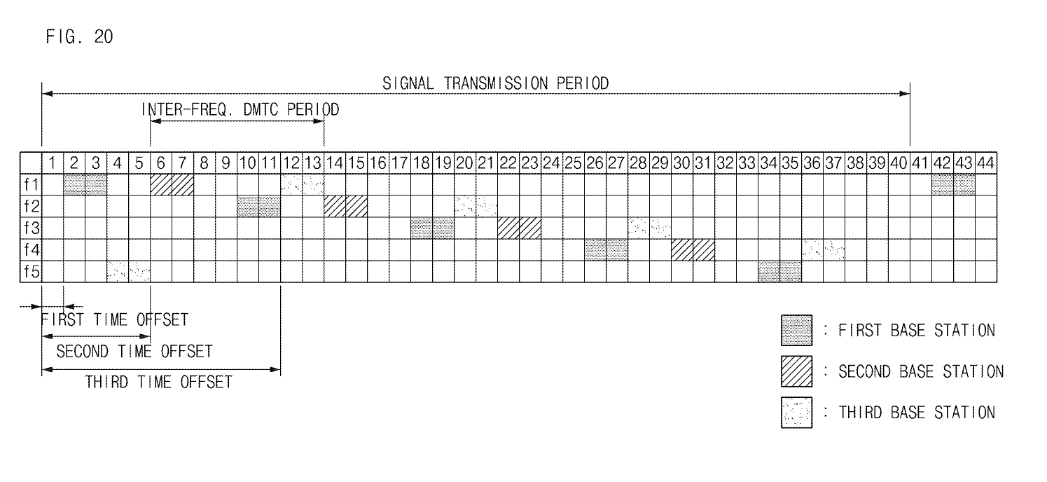

Hereinafter, a method of transmitting a DRS by a plurality of base stations (for example, a first base station, a second base station, and a third base station) will be described with reference to FIG. 20. As an example, it is described that three base stations are provided, but the present invention is not limited thereto. Each base station which will be described below includes the transmission control unit 1100 and the communication unit 1200 which have been described above.

A first base station eNB1 transmits a first discovery reference signal to the outside at a different timing for each of the plurality of channels (that is, f1 to f5). A second base station eNB2 transmits a second discovery reference signal to the outside at a different timing for each of the plurality of channels (that is, f1 to f5). A third base station eNB3 transmits a third discovery reference signal to the outside at a different timing for each of the plurality of channels (that is, f1 to f5).

The first base station eNB1, the second base station eNB2, and the third base station eNB3 transmit the first discovery reference signal, the second discovery reference signal, and the third discovery reference signal to the outside, respectively, in the DMTC period.

The first base station eNB1 transmits the first discovery reference signal to the outside at a first timing of the first channel f1 (for example, a timing when a subframe index of the DMTC of FIG. 20 is 2) and transmits the first discovery reference signal to the outside at a timing apart from the first timing of the second channel f2 by an inter-freq. DMTC period. The inter-freq. DMTC period may be determined based on the DMTC period and the number of the plurality of channels. The first base station eNB1 sets a first time offset to determine the first timing and the first time offset may be determined based on the DMTC and a physical cell identity (PCI) of the first base station eNB1.

The second base station eNB2 transmits the second discovery reference signal to the outside at a second timing of the first channel f1 (for example, a timing when a subframe index of the DMTC of FIG. 20 is 6) and transmits the second discovery reference signal to the outside at a timing apart from the second timing of the second channel f2 by an inter-freq. DMTC period. The second base station eNB2 sets a second time offset to determine the second timing and the second time offset may be determined based on the DMTC and a physical cell identity (PCI) of the second base station eNB2.

The third base station eNB3 transmits a third discovery reference signal to the outside at a third timing of the first channel f1 (for example, a timing when a subframe index of the DMTC of FIG. 20 is 10) and transmits the third discovery reference signal to the outside at a timing apart from the third timing of the second channel f2 by an inter-freq. DMTC period. The third base station eNB3 sets a third time offset to determine the third timing and the third time offset may be determined based on the DMTC and a physical cell identity (PCI) of the third base station eNB3.

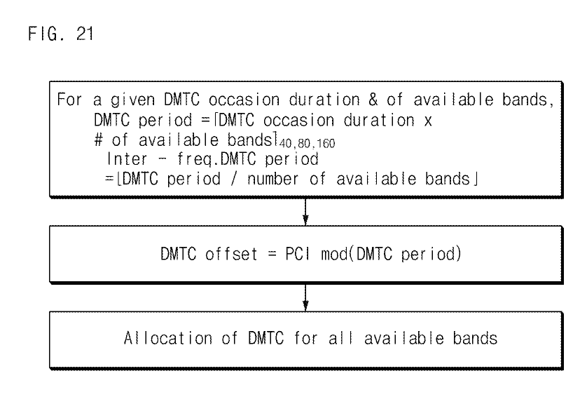

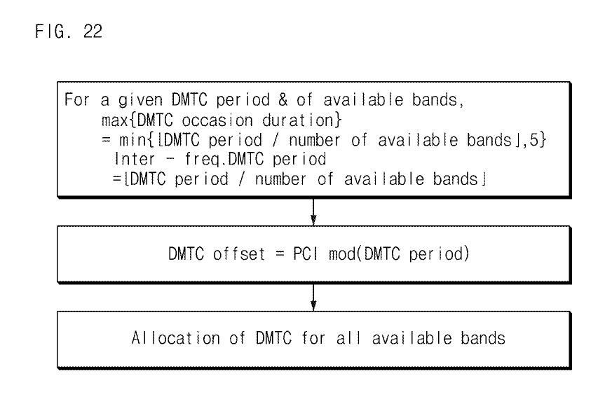

Hereinafter, a process of setting the DMTC, the inter-freq. DMTC period, and the time offsets (the first time offset, the second time offset, and the third time offset) will be described in more detail with reference to FIGS. 21 and 22.

For example, referring to FIG. 21, when the number of available channels (that is, the number of the plurality of channels, # of available bands) and a DRS transmission period (DMTC occasion duration) are given, the DMTC period may be defined by the following Equation 29.

DMTC period=[DMTC occation duration×# of available bands]_{40,80,160} [Equation 29]

In this case, └X┘₄₀₈₀₁₆₀ refers to a minimum value of 40, 80, and 160 among numbers which are larger than X, which is determined in accordance with the DMTC period defined in the standard. The meaning of Equation 29 results from the fact that only when the product of the number of channels which transmit the DRS and the DRS transmission period is smaller than the DMTC period, the DRS is transmitted to all available channels in the DMTC period.

In the meantime, referring to FIG. 22, when the number of available channels and the DMTC period are given, a maximum length of the DRS transmission period (DMTC occasion duration) may be determined by the following Equation 30.

max{DMTC occation duration}=min([DMTC period/number of available bands], 5) [Equation 30]

In this case, └x┘ is a maximum value among integers which are smaller than x and min{x,y} means a smaller value between x and y. The standard suggests the maximum length of the DRS transmission period (DMTC occasion duration) as five subframes. However, when a length of the DRS transmission period is longer than a value obtained by dividing the DMTC period by the number of available channels, it is impossible to transmit the DRS to all the available channels in the DMTC period, so that a length of the DRS transmission period is restricted as represented in Equation 30, in the transmission of the DRS in the unlicensed band.

The transmission interval between channels (inter-freq. DMTC period) may be defined using the above Equations 29 and 30, as represented in the following Equation 31.

Inter−freq. DMTC period=[DMTC period/number of available bands] [Equation 31]

The inter-freq. DMTC period indicates a length from a transmission timing of a channel which transmits a current DRS to a transmission timing of a channel which transmits a next DRS in the DMTC period. The inter-freq. DMTC period may have a large value due to an interference problem due to the transmission of the DRS if possible. However, in order to transmit the DRS to all the available channels in the DMTC period, the inter-freq. DMTC period may be restricted as represented in Equation 31.

In the meantime, if it is possible to exchange information between the base stations, different time offsets (DMTC offsets) are allocated to every base station and transmission conflict of the DRS may be prevented, which may actually cause lots of restrictions. Therefore, the present invention suggests a method of using physical cell identity (PCI) to determine a time offset so that the base stations have different time offsets without exchanging information between the base stations. The PCI is a unique number which identifies each cell and the base stations have different PCIs. In the standard, there are total 504 PCIs and different base stations are distinguished using the PCIs. Therefore, when the time offset is determined using different PCIs for every base station, a probability of conflict at the time of transmitting the DRS is reduced, which is represented by the following Equation 32.

DMTC offset=PCI mod(DMTC period) [Equation 32]

For example, with respect to the DMTC period of FIG. 19, when PCI of the first base station eNB1 is 81, PCI of the second base station eNB2 is 45, and PCI of the third base station eNB3 is 51, the time offsets (DMTC offsets) are 1, 5, and 11. From the viewpoint of materialization, the PCI may be allocated so as not to overlap the DRS transmission periods (DMTC occasion durations) between adjacent base stations while considering the time offset in the unlicensed band.

For example, when the DRS transmission period (DMTC occasion duration) is 2 and the number of available channels is 5, the DMTC period is 40 based on Equation 29. The inter-freq. DMTC period in this case is 8 in accordance with Equation 31. Therefore, the first base station eNB1 has the first time offset 1 at the first channel f1 to transmit the first discovery reference signal at the second subframe and transmit the first discovery reference signal at a tenth subframe in which the inter-freq. DMTC period of 8 is added, at the second channel f2.

The second base station eNB2 has the second time offset 5 and thus starts to transmit the second discovery reference signal at a sixth subframe of the first channel f1 and transmit the second discovery reference signal at a 14th subframe in which the inter-freq. DMTC period of 8 is added, at the second channel f2.

The third base station eNB3 has the third time offset 11, to transmit the third discovery reference signal at a 12th subframe of the first channel f1 and transmit the third discovery reference signal at a 20th subframe of the second channel f1, a 28th subframe of a third channel f3, a 36th subframe of a fourth channel f4, and a 44th subframe of a fifth channel f5.

However, when the DMTC period is 40 ms, the 44th subframe is out of the DMTC period, so that an index of the subframe in which the DRS is transmitted at f1 is 44 (mod) DMTC period=4. Therefore, the third base station eNB3 transmits the DRS using the fourth subframe at f5. Hereinafter, a process of setting the DMTC period, the inter-freq. DMTC period, and the time offsets (the first time offset, the second time offset, and the third time offset) may be more apparently appreciated from FIGS. 21 and 22.

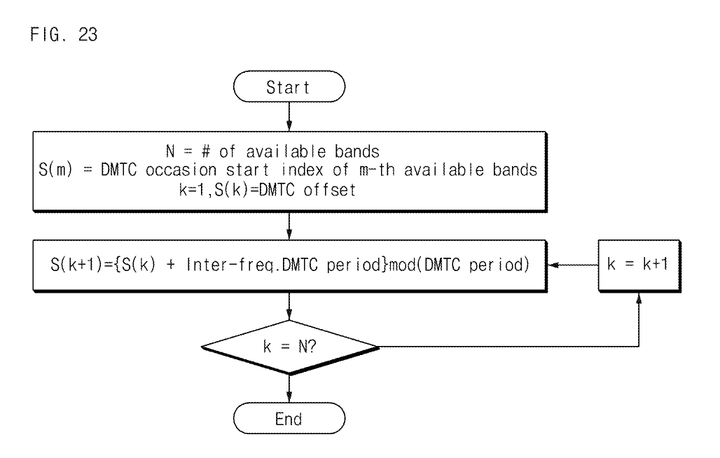

In the meantime, a process of determining a timing (that is, a subframe index when the transmission starts) when the DRS is transmitted at each channel is generalized as illustrated in FIG. 23. That is, FIG. 23 illustrates a method of determining S(1), S(2), . . . , S(N) when the number of available channels in the unlicensed band, that is, the number of channels which transmit the DRS is N and S(m) is a DRS transmission starting index of the base station in an m-th channel.

First, when k=1 (that is, the first channel), the DRS transmission starting index may be the same as the time offset. Therefore, S(1) is a time offset. At the second channel (k=2), the DRS transmission starting index is a time apart from the DRS transmission starting index S(1) of the first channel by the inter-freq. DMTC period. Therefore, S(2)=S(1)+inter-freq. DMTC period.

In the meantime, similarly to the fifth channel (f5) of the third base station eNB3 of FIG. 19, when the DRS transmission starting index exceeds the DMTC period, all the DRS transmission starting indexes need to be within the DMTC period through a mod (DMTC period) operation. When the above processes are performed from k=1 to k=N, that is, on all the available channels, the DRS transmission scheduling in the unlicensed band of the base station will be completed.

As described above, the base station according to the exemplary embodiment of the present invention and the communication system including the base stations may provide a method for allowing a plurality of base stations to transmit the DRS to the outside through a plurality of channels without causing conflict.

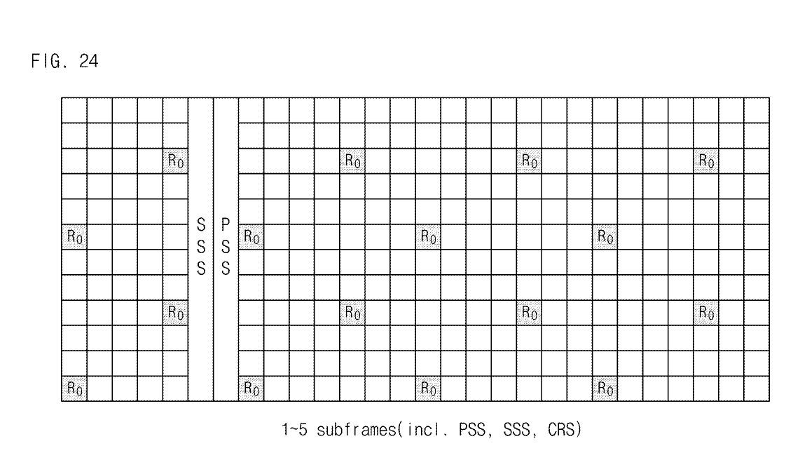

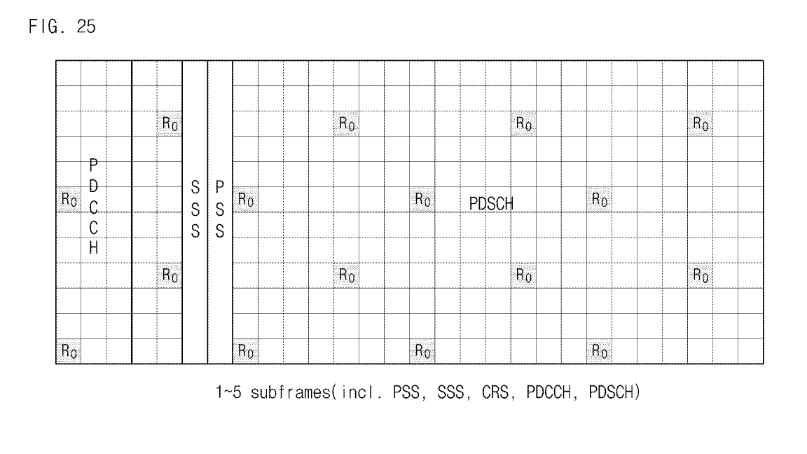

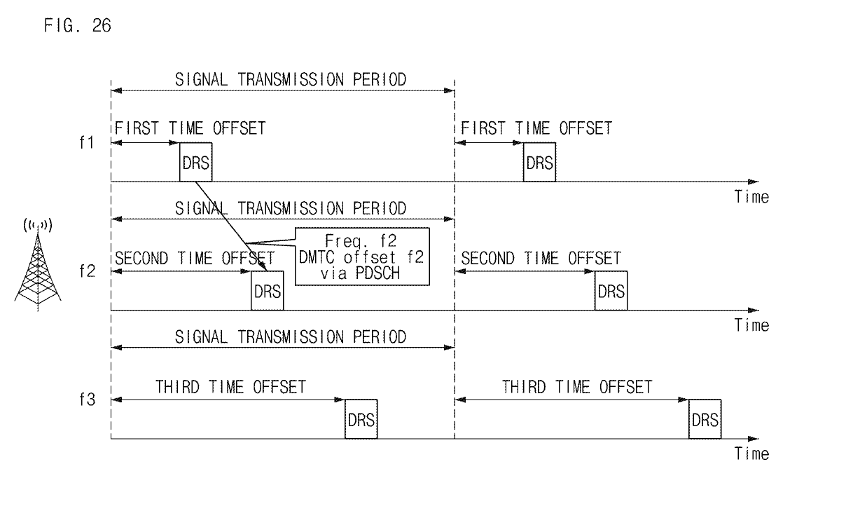

FIG. 24 is an example of a general discovery reference signal. FIGS. 25 and 26 are examples of a general discovery reference signal according to an exemplary embodiment of the present invention.

Referring to FIG. 24, a structure of a general DRS is illustrated. The DRS is configured by one to five subframes in the case of an FDD system and is configured by two to five subframes in the case of a TDD system and includes PSS, SSS, and CRS components and optionally includes a channel state information—reference signal (CSI-RS). It is designed to estimate a channel state and estimate approximate synchronization which is an original purpose of DRS signal transmission. In the meantime, in order to transmit the DRS to the plurality of channels in the unlicensed band, it is required to notify a terminal which receives the DRS at a time t of a first channel f1 of information indicating that the DRS is transmitted at a time t2 in a second channel f2. To this end, similarly to a general subframe, control information (physical downlink control channel: PDCCH) and data (physical downlink shared channel: PDSCH) may be transmitted with respect to the DRS. For example, the DRS and the control information (PDSCH or PDCCH) may be multiplexed in the subframe.

FIG. 25 illustrates a configuration example of a DRS signal including the PDCCH and the PDSCH. A general DRS of FIG. 24 does not transmit a resource element (RE) other than the PSS, the SSS, and the CRS but in an example of FIG. 25, information on DRS transmission may be transmitted through transmission of the PDCCH and the PDSCH.

FIG. 26 illustrates an example of DRS transmission using the DRS illustrated in FIG. 25. That is, FIG. 26 is appreciated as an example in which one base station transmits the DRS to the terminal at different times through a plurality of channels.

The base station eNB transmits the DRS using a first time offset at a first channel f1 and the terminal estimates channel status information and approximate synchronization using the DRS. Further, the terminal receives the PDCCH and the PDSCH to obtain information on a second channel f2 which is a next DRS transmission channel and information of a second time offset (DMTC offset 2) which is a DRS transmission timing in the second channel f2. The terminal may effectively receive the DRS of the base station eNB in the second channel f2 using the information.

In the meantime, in the DRS configuration in the unlicensed band, a maximum length of the DRS may be restricted to 1 ms or shorter, that is, one subframe or shorter. Further, after transmitting the DRS, in order to perform LBT to transmit an unlicensed band burst, the DRS which is 1 ms or shorter may restrict the last OFDM symbol or the last OFDM symbol and an OFDM symbol prior to the last OFDM symbol to configure the CSI-RS. The period may be used as a period when the base station or the terminal performs the LBT. For example, the DRS may be configured by 12 OFDM symbols or 13 OFDM symbols.

Further, when the DRS and the PDSCH are multiplexed, a position of the subframe where the DRS and the PDSCH are multiplexed may be restricted. In an environment where a transmission location of the PSS and the SSS among the DRS components is changed from subframe 0 to subframe 9, the multiplexing of the DRS and the PDSCH may be restricted so as to be performed only at subframe 0 to subframe 5. In this case, subframe 0 and subframe 5 are subframes at which the PSS and the SSS are transmitted, among general LTE frames.

In the meantime, if the DRS and the PDSCH can be multiplexed at other subframes except subframes 0 and 5, when the DRS and the PDSCH are multiplexed, information indicating whether to multiplex may be transmitted from the base station to the terminal. When the terminal performs processes of detecting and demodulating a specific subframe, a configuration of a PDSCH resource varies depending on whether the DRS is multiplexed with the PDSCH. Therefore, the base station may provide information thereon. In this case, whether to multiplex the DRS at the subframe may be displayed in downlink control information (DCI) in the PDCCH or the EPDCCH. Alternately, the terminal may determine whether to multiplex the PDSCH and the DRS by detecting the PSS, the SSS, or the CRS in the subframe. In this case, when the DRS and the PDSCH are multiplexed, the base station configures the sequence configuration of the CRS to be different from the subframe number of the PCell or the PSCell to transmit whether to multiplex the DRS, to the terminal. When carrier aggregation technique is used, the terminal may obtain subframe time synchronization using a licensed band cell. In this case, a subframe boundary of the time synchronization of the unlicensed band cell may be set to be the same as that of the licensed band cell.

For example, when the subframe number of the current licensed band cell is 2, the subframe number of the unlicensed band cell may also be 2. In contrast, when the DRS in the unlicensed band is multiplexed, the terminal may obtain time synchronization which is different from the subframe number of the licensed band by detecting the DRS of the unlicensed band. When the subframe number of the licensed band is different from the subframe number of the unlicensed band, it is determined that the DRS is multiplexed to the subframe. In other words, when the DRS is multiplexed to the PDSCH in the base station, the PSS, SSS, and CRS sequences in the subframe are set to be different from the subframe numbers of the licensed cell and then transmitted. Additionally, with respect to the subframe to which the DRS is multiplexed, whether the PDSCH and the DRS are multiplexed may be indicated using a PHICH or a PCFICH sequence.

In the meantime, in view of the terminal, when the DRS is restricted to be transmitted only in the DMTC period, whether the DRS and the PDSCH are multiplexed is detected or information confirmation is performed only in the DMTC period.

Further, the PDSCH and the DRS are multiplexed in the same bandwidth in one subframe, but the PDSCH and the DRS may be time-division multiplexed (TDM) or frequency division multiplexed (FDM). In one unlicensed band burst, the DRS is transmitted at one subframe and the PDSCH is transmitted at the other subframe. Further, when the DMTC period starts during the unlicensed band burst transmission period, the DRS may be transmitted in the DMTC period. Further, when the DRS is transmitted only to a part of the transmission bandwidth of the base station, the PDSCH may be transmitted in a bandwidth where the DRS (PSS or SSS) is not transmitted.

It will be appreciated that various exemplary embodiments of the present disclosure have been described herein for purposes of illustration, and that various modifications, changes, and substitutions may be made by those skilled in the art without departing from the scope and spirit of the present disclosure.

Accordingly, the exemplary embodiments disclosed herein are intended to not limit but describe the technical spirit of the present invention and the scope of the technical spirit of the present invention is not restricted by the exemplary embodiments. The protection scope of the present invention should be interpreted based on the following appended claims and it should be appreciated that all technical spirits included within a range equivalent thereto are included in the protection scope of the present invention.

1-9. (canceled)

10. A communication system including a base station which transmits a discovery reference signal (DRS) in an unlicensed band, the communication system comprising:
a first base station which transmits a first DRS to the outside at different timings for each of a plurality of channels; and
a second base station which transmits a second DRS to the outside at a timing which is different from that of the first DRS, through the same channel as the plurality of channels of the first base station.

11. The communication system of claim 10, wherein the first base station transmits the first DRS to the outside in a signal transmission period which is set for the plurality of channels and the second base station transmits the second DRS to the outside for the plurality of channels in the signal transmission period.

12. The communication system of claim 11, wherein the first base station transmits the first DRS to the outside at a first timing of a first channel and transmits the first DRS to the outside at a timing apart from the first timing of a second channel by an inter-freq. Discovery reference signal Measurement Timing Configuration (DMTC) period.

13. The communication system of claim 12, wherein the second base station transmits the second DRS to the outside at a second timing of the first channel and transmits the second DRS to the outside at a timing apart from the second timing of the second channel by the inter-freq. Discovery reference signal Measurement Timing Configuration (DMTC) period.

14. The communication system of claim 13, wherein the second base station sets a second time offset to determine the second timing and the second time offset is determined based on the signal transmission period and physical cell identity (PCI) of the second base station.

15. The communication system of claim 12, wherein inter-freq. DMTC period is determined based on the signal transmission period and the number of the plurality of channels.

16. The communication system of claim 12, wherein the first base station sets a first time offset to determine the first timing and the first time offset is determined based on the signal transmission period and the PCI of the first base station.

17. The communication system of claim 10, wherein the first DRS or the second DRS includes physical downlink control channel (PDCCH) information or physical downlink shared channel (PDSCH) information.

18. The communication system of claim 17, wherein the first DRS or the second DRS is multiplexed with the PDCCH information or the PDSCH information in the subframe.

19. The communication system of claim 18, wherein the first DRS or the second DRS is multiplexed with the PDCCH information or the PDSCH information in subframe 0 or subframe 5.

20. The communication system of claim 10, wherein the first DRS or the second DRS is configured by 12 OFDM symbols or 13 OFDM symbols.
